(19) United States
(12) Patent Application Publication
(10) Pub. No.: US 2013/0054484 A1
(43) Pub. Date: Feb. 28, 2013

(54) SYSTEMS, METHODS AND APPARATUSES FOR PRODUCING A COMPETITIVE GIVING MARKET-PLACE THROUGH A SOCIAL IMPACT MARKETING PLATFORM

(71) Applicant: SHAREMEISTER, INC., Pasadena, CA (US)

(72) Inventors: Jonathan W. Hoeflinger, Fresno, CA (US); Marlon Henderson, JR., Jonesboro, AR (US)

(73) Assignee: SHAREMEISTER, INC., Pasadena, CA (US)

(21) Appl. No.: 13/665,071

(22) Filed: Oct. 31, 2012

Related U.S. Application Data
(63) Continuation-in-part of application No. 12/354,661, filed on Jan. 15, 2009.
(60) Provisional application No. 61/553,867, filed on Oct. 31, 2011.
(60) Provisional application No. 61/023,155, filed on Jan. 24, 2008.
(60) Provisional application No. 61/107,277, filed on Oct. 21, 2008.
(60) Provisional application No. 61/107,984, filed on Oct. 23, 2008.

(51) Int. Cl. G06Q 99/00

(52) U.S. Cl. 705/329

(57) ABSTRACT

Systems, methods and apparatuses for producing a competitive giving marketplace through a social impact marketing platform is disclosed. A portal for consumers, merchants, nonprofits, merchant processors, and financial institutions (participants) is provided to interact in the online and physical marketplace connected to the portal and may create and host competitive events to generate revenues for a designated nonprofit, purpose or cause. An administrative system coordinates the relationship between participants and the receipt of revenue generated for participants. The system and method disclosed provide ways for participants to measure, verify, and market the generated revenue through a portal, in order to combine and direct designated revenues for a designated nonprofit or other purpose in a competitive giving marketplace.

This is a continuation-in-part of co-pending U.S. utility application Ser. No. 12/354,661 filed on Jan. 15, 2009 which claims the benefit of U.S. provisional application No. 61/023,155 filed on Jan. 24, 2008, of U.S. provisional application No. 61/107,277 filed on Oct. 21, 2008, and of U.S. provisional application No. 61/107,984 filed on Oct. 23, 2008, all of which are incorporated herein by this reference in their entirety.

This application also application claims the benefit of U.S. provisional application No. 61/553,867 filed on Oct. 31, 2011 which is incorporated herein by this reference in its entirety.

### BACKGROUND OF THE INVENTION

1. Field of the Invention

The present disclosure relates generally to the measuring, verifying, and marketing of the financial giving of participants. More specifically, the present disclosure relates to systems, methods and apparatuses for generating revenues or other things of value by participants for the benefit of designated nonprofits, purposes or causes through a user interface or portal. In some embodiments, participants may connect to the portal and combine and/or compete with other participants, in a competition giving event.

2. Description of the Prior Art

Nonprofit organizations, startups and new business ventures are constantly faced with fundraising challenges. These challenges increase in a bad economy because consumers have a low confidence in the marketplace and are concerned about the future of the economy. As a result, in a down economy consumers spend less on products and services and give less to nonprofits, purposes or causes they traditionally support. Government grants to nonprofits have recently lowered to the point that nonprofits can no longer sustain themselves through government subsidies. Meanwhile, businesses continue to seek ways to drive sales and improve marketing. Many merchants desire to assist nonprofits and give to social purposes or causes.

One way that merchants have helped nonprofits, purposes or causes is by making a direct request for a donation at checkout. However, consumers are not always pleased when asked by a merchant to reach into their pocket a second time to add to their purchase total, particularly if they do not care to support the nonprofit, purpose or cause selected by the merchant. Another way that merchants or financial institutions have helped nonprofits, purposes or causes is by giving consumers the opportunity to flag their accounts so that their purchases with the merchant or through the financial institution generate revenue or other value for a designated nonprofit, purpose or cause. This has been successful to some degree, but does not leave the consumer with any opportunity to choose the nonprofit, purpose or cause that receives the benefit, or to cause any benefits to be created other than through purchases.

Another way that merchants have helped consumers benefit nonprofits is through competitive events. One example is illustrated by a merchant such as Ralston Purina Co. which operates a website that allows consumers to cast a vote for a cat or a dog, with each vote generating a dollar amount (e.g. $1, with a $100,000 cap) that is donated to a cause supported by the company. Unfortunately, this may only be appealing to pet lovers, and any donations are given only to the limited cause selected by the company. Another example is disclosed in U.S. Patent Publication No. 2011/0208647 in which a campaign is established by a merchant such as Starbucks who makes it known that it intends to make a donation to charitable causes, and allows consumers to vote for which cause(s) they believe should receive some or all of the funds to be donated. However, this does not allow the consumers to make any donations themselves or otherwise participate directly in any charitable giving.

It is therefore desirable to provide systems, methods and apparatuses to provide a clearinghouse that allows merchants, consumers and financial institutions to directly participate in wide ranging giving opportunities that stem from ordinary business activities which involve the consumer (such as, without limitation, making purchases, voting for things, or simply browsing on the Internet) that provide marketing and promotional benefits to the financial institutions and merchants, and provide financial benefits to nonprofit organizations or other purposes or causes.

### SUMMARY

The present disclosure provides systems, methods and apparatuses that allow organizations needing funding and for-profit business to meet in the middle—providing access to tools to help support the cause(s) of the organizations needing funding, while also providing exposure and marketing for the businesses. Sustainable giving begins by sustaining business. Embodiments of the invention may also be directed toward generating revenue of funding for things other than nonprofit organizations such as merchant products, product development, programs, particular proposals, ideas or other purposes or causes.

The present disclosure provides systems, methods and apparatuses in which a Portal links to financial institutions and to merchant processors, offering revenue or incentives in exchange for referring consumers and merchants, while linking to revenue generating tools connected to the Portal which produce new sources of sustainable revenue for nonprofits, purposes or causes at no out-of-pocket expense to the consumer.

In some embodiments, participants, primarily consumers, may access several platforms to ensure nonprofits of their choice benefit from transactions in their daily lives without money coming directly out of their wallet or by changing their price-point.

The present disclosure provides systems, methods and apparatuses to measure, verify, and market the financial giving and social interaction, sometimes referred to as the “social impact” of participants through the Portal. In embodiments of the invention, participants may be linked together through teams focused on benefiting a given nonprofit and provided with revenue generating tools and marketing tools to compete with other teams, thereby driving the marketplace which has the potential ability to fully sustain nonprofits.

Embodiments of the invention provide a gaming application that takes everyday interactions between participants (spending time online, making purchases online or in a store, engaging with brands through competition) and converts it into money or value that can be used to give to causes. These embodiments may convert money into points/credits to ensure every marketplace interaction produces revenue or value that may be directed to a cause. Some embodiments utilize competitive events to accumulate points/credits which are distributed to the nonprofit, purpose or cause at the end of the event. Merchants benefit from these embodiments through marketing and brand exposure.

Embodiments of the invention market the social impact of participants in a passive giving format. These embodiments are designed to benefit nonprofits, purposes or causes through everyday interactions that produce revenue, minimize the financial burden on the giver, and/or provide ways to convert the giving into marketing. These embodiments produce more sales, which in turn, produce more giving opportunities.

Embodiments of the invention also measure the transaction(s) of participants to determine an efficient return on investment. These embodiments may link any device, website, third party API, etc. to the Portal to ensure all giving (direct or passive) is directly related back to the transaction, points/credits are properly awarded, and any giving transaction is marketable by participants.

In embodiments of the invention, participants may quantify their total social impact connected to the Portal through a Social Impact Meter. The Social Impact Meter is a way of measuring the ultimate benefit received by the nonprofit, purpose or cause (e.g., the amount of money received by the nonprofit and its use of proceeds per its mission), and is ordinarily based on revenue, or any form of money or value, generated through an embodiment of the invention by a merchant and/or consumer. These benefits may come from direct monetary donation, quantified service, and/or gift; or indirectly through revenue generating tools linked to the Portal (interactions with the Portal, competitive events, and the like discussed more fully below) which produce indirect donations for nonprofits, purposes or causes.

In embodiments of the invention, participants may qualify the motives and actions of other participants by rating their experiences through an Integrity Meter. The integrity meter is a crowd-sourcing tool to keep accountable participants interacting inside and outside the portal. The Integrity Meter may take into account the negative and positive feedback of such things as: (1) a purchase experience, (2) an ad campaign experience (which helps a company improve giving by receiving negative and positive feedback on the campaign), (3) types of nonprofits receiving donations, (4) how much was given (for merchants/consumers), (5) how the giving was used (by the nonprofits, purposes or causes) and/or (6) general positive or negative feedback. In any event, through the integrity meter, merchants are made accountable by both the fund recipients and consumers; consumer made accountable by both merchants and nonprofits; and nonprofits made accountable by both consumers and merchants.

A Competitive Giving Marketplace (CGM) such as that provided by embodiments of the present invention drives the overall impact of consumers and merchants through friendly competition to provide funding for nonprofits, purposes or causes. Embodiments of the invention are designed to group consumers around any brand to stimulate commerce for participants and to sustain nonprofits, purposes or causes associated with the competitive event; additionally to encourage viral growth around a nonprofit, purpose or cause as teams compete and seek out new members online and in their communities to win the competition.

Events inside the CGM are customizable and include a structure of consumers engaging with brands through competitive giving events to benefit nonprofits and marketed by all participants. In this context, “engaging” may refer to many things such as, without limitation, viewing an advertisement in an application linked to portal, making a purchase through a device, website, third party API that is linked to portal, and/or joining a team of a competitive event linked to portal, etc. These are samples of a long list of examples (e.g. Revenue Generating Tools linked to Portal, discussed below). In this context, a “brand” may refer to, without limitation, a source identification such as a consumer, nonprofit, and/or merchant. For example, a well-known business (such as a national retail store) may be a brand that encourages consumers to participate; a high-profile consumer (such as an actor, athlete or celebrity) may act as a brand that encourages consumers to participate; and a well-known nonprofit (such as the Red Cross) may also encourage consumers to participate Finally, in this context, “competitive giving event” may refer to, without limitation, active participation in a game or event where teams are established and compete with each other that include one or more consumer, one or more nonprofit, purpose or cause, and one or more merchant linked together in the same event; include one or more marketing tools; include one or more revenue generating tools to produce “passive giving” opportunities for participants; where all revenue generated for a nonprofit, purpose or cause is converted into a point; or where a personalized game board is developed and competitors race to the end, crowd sourcing, and countless other variations and/or combinations.

In embodiments of the invention, the Social Impact Marketing Platform facilitates a CGM including Competitive Giving Events that may: (a) group people around any form of brand to (b) generate revenues for nonprofits, purposes or causes from (c) interactions that produce revenue from everyday known activities. Interactions may include, without limitation, purchasing with a rewards card linked to portal, spending time online with an application linked to portal, making an online purchase with a website linked to portal, etc.

By way of a first example, and without limiting the claims herein, one embodiment of a competitive giving event may include two or more participants who create teams and compete to determine such things as:

(a) which team can generate the most team members,

(b) which team does the most giving (direct or passive) to a nonprofit per team,

(c) which team produces the most sales relating to the brand,

(d) which team aligns best with a rule or set of rules created by the participant administrator of the event and agreed to by one or more opposing teams, and/or

(e) any combination or permutation of a, b, c, & d above.

Such a competitive giving event may combine giving of one or more teams to benefit one or more nonprofits, purposes or causes and/or separate the giving to one or more nonprofits based upon the distribution of giving as designated by each team member and/or by team percentage of total giving per competitive event. For example, and without limitation, a competitive giving event may be designed such that all proceeds from all teams go to a single nonprofit, purpose or cause that needs funding; however, in other examples, the proceeds generated by each team may each go to a different nonprofit, purpose or cause; and in other examples proceeds may be divided up among designated nonprofits, purposes or causes by percentages or other means. Every competitive giving event may be customized by the participants.

Any number of teams may compete around a single nonprofit, purpose or cause during a competitive event. Other teams may generate revenue for the same nonprofit, purpose or cause and not participate in a competition. Revenue generated after a consumer or merchant joins a team may be counted to the overall total of the team. Merchants may join teams to generate new revenue and entice a consumer motive to win the competition event and benefit the designated nonprofit by purchasing an item through the revenue generating tools connected to the portal.

By way of a second example, and without limiting the claims herein, another embodiment of a competitive giving event may include an event where a single participant engages in a personalized game board, and each space on the game board may represent an objective to complete relating to a “marketing tool” a “revenue-generating tool” or the like, that is linked to the Portal. For example, a space may represent a particular merchant The game board may consist of one or many merchant stores (spaces) where the purpose of each consumer is to shop at the store; where the merchant agrees to give a portion of each captured transaction, via device linked to portal, to a designated nonprofit, purpose or cause. When the consumer purchases from each merchant representing a space on the board, the consumer wins a reward AND generates desired revenue for a nonprofit, purpose or cause. Revenue designated for a nonprofit, purpose, or cause are converted into a point via the clearinghouse and distributed accordingly. Participants may or may not race against other participants around the board, to see who completes the challenge first. If a “race” is set up, a “prize” may be established by a merchant sponsor and provided to the “winner”. Participants may also customize the game board. In such embodiments, the Portal raises money for nonprofits, purpose or causes and provides personal rewards for the user through interaction with brands, individually or collectively. The exemplary event may be co-branded with any existing board game brand linked to the Portal, or it may be unique to the participant's specifications.

In some embodiments, an interaction can be linked to each space on a game board. As participants interact with each other through Revenue Generating Tools, Marketing Tools, or CGM linked to the portal—the spaces on a game board can be created and can be filled. Each interaction measures, verifies, and converts revenue into points, which may become designated revenue for nonprofits, purposes or causes. (In rare cases, it is possible for a participant to be a merchant, consumer, and nonprofit at the same time or combination of two out of three.)

By way of a third example, and without limiting the claims herein, another embodiment of a competitive giving event may include crowd-funding. Competing brands may be opposing merchants or nonprofits raising money for a new business venture or new mission, respectively. Revenue created through revenue generating tools (discussed elsewhere) and converted to points/credits through the Portal may be used to raise capital for either type of team. In different variations, participants may give directly at an out-of-pocket expense, as appropriate.

One purpose of an event may be to promote and engage consumers around a brand and generate revenue for a nonprofit, purpose or cause that can be marketed by all participants. This can be done through team competition or by a participant moving through a pre-determined set of steps (such as a board game) to achieve a personal goal. Such processes raise money for nonprofits, purposes or causes from revenue generating tools that aid in producing points for purposes of giving and provide personal rewards for the user through interaction with brands, individually or collectively.

Portal Description.

An exemplary Portal of the present invention may (a) convert an interaction linked to the Portal into a point/credit that (b) can be directed to any nonprofit, purpose or cause and (c) marketed by participants. An exemplary portal may be comprised of, without limitation:
1. a clearing house (gateway) that is capable of converting any monetary unit into a point/credit for donative and/or commerce purposes, converting point/credit into any monetary unit, producing a monetary value per point/credit, balancing all point/credit accounts of participants, and/or exchanging credits/points for products/services/currencies. It is to be appreciated that in embodiments of the invention, different monetary units (dollars, pesos, yen) may be converted into “points” or “credits” and that such points or credits may also be generated without direct monetary donations. The points or credits are then valued on a periodic basis and converted back into monetary units when distributed to the nonprofit, purpose or cause. Once donated the value of a point is set.
2. a distribution channel designed to distribute revenues (e.g. points/credits) to nonprofits as directed by consumers and merchants, distribute events to participating third party entities (e.g. social media channels), and distribute products/services for rewards to participants;
3. a marketing engine that measures, verifies, and markets the financial giving and social impact of all participants through an Administrative System (Social Impact/Enterprise Marketing Platform) and CGM;
4. A database that correlates all transactional and advertising data and analytics across every Portal element linked to Participants; determines marketing return on investment and return on community.

Embodiments of the Social Impact (Enterprise) Marketing Platform & CGM may be made up of four known components: Social Networking, Gaming, Commerce, and Philanthropy.
1. Social Networking: Embodiments of the portal enable users to join the team of their favorite brand; join together around their favorite nonprofits, purposes or causes; group different brand and/or nonprofits together to show support. The brand could be any participant. Participants are able to market their giving through marketing tools and/or competitive events and/or revenue generating tools to engage with the philanthropic or commerce desires of other participants; and additionally may share philanthropic results on social media outlets.
2. Gaming: Embodiments of the portal enable users to play games that include all participants. Competitions engage consumers with merchants via transactions (or vice-versa via advertisements) to benefit nonprofits, purposes or causes. Teams compete against other teams and/or participants compete against other participants and/or a participant may compete against themselves.
3. Commerce: Any form of existing commerce method may be used as a revenue generating tool (including without limitation, Point-of-Sale service, E-commerce website, Gateway, Financial Institution, Reward Card, Credit/Debit interchange, Pre-paid card, Advertising platform, Marketing platform, Text service, Survey Platform, Data collection, Fees, or any technology or service that can be measured, or measures an exchange or transaction between two parties) can be linked to embodiments of the Portal to produce, convert, consolidate, join, combine, unite, and/or merge revenues into a point/credit. The point/credit can be utilized by participants for donative or commerce purposes.
4. Philanthropy: Embodiments of the portal provide a new definition of giving to nonprofits or doing commerce by allowing existing commerce services to “opt-in” to the Portal to allow participants to (a) give without any money coming out of pocket, (b) give without changing their price-point, (c) maximize their giving opportunity at point-of-sale, (d) market the giving through various “marketing tools,” and/or (e) give to any nonprofit of choice. This relates designated revenue for nonprofits and how that is presented through marketing tools.

Embodiments of the portal may link three groups, which may be referred to as either “participants” or “users” or “brands”:
1. Consumers such as, without limitation, individuals, celebrities, public figures, and the like.
2. Merchants such as, without limitation, any LLC, B-corporation, C-corporation, start-up seeking funding, or any other formal for-profit entity.
3. Nonprofits such as, without limitation any foundation, political entity, church, rescue mission, university, school district, or any other non-profit entity (e.g. 501(c)(3), 501(c)(4), 509(a)(1), 509(a)(2), etc.)

Embodiments of the Social Impact (Enterprise) Marketing Platform may include one or more marketing tools including the following:
1. Social Impact Meter
2. Integrity Meter
3. Participant Home Pages
4. Billboard & Ranking of Participants linked to Portal
5. Database & Analyze Tools that measure Participant interactions.

Participants may visit the Portal to view the philanthropic impact of other Participants or visit their respective websites and/or social media outlets from embedded code that is linked back to the Portal. It is to be appreciated that in some embodiments, consumer participants may have the option of keeping their identities or giving information private. In these embodiments, the consumer decides whether or not others visiting the Portal will be allowed to see the consumer's page, to see them amounts given by that consumer, or to see the identities of those receiving those amounts.

Embodiments of the CGM may include, without limitation:
1. Any Competitive Giving Event referred to in the examples herein.
2. Any combination of (a) the examples as customized by participants potentially including three groups: consumers, merchants, and nonprofits, and (b) Revenue Generating Tools linked to Portal that produce “passive giving” opportunities, and (c) any Point/Credit designated for donative or commerce purposes.
3. Any of the Building Blocks (FIG. 23) that lay the foundations that form the CGM.

Embodiments of the Revenue Generating Tools link to Social Impact (Enterprise) Marketing (SIM) Platform and Competitive Giving Marketplace (CGM) may include, without limitation:
1. Any proprietary or third party device, website, Browser application, card (credit, debit, pre-paid, reward, gift, etc), mobile platform, Application Programming Interface (API), portal, ad server, marketing platform, search engines, payment processors, or any other device capturing an interaction between participants/users that is linked to the Portal.
   It is to be appreciated that embodiments of the invention may use a broad range of transactions as revenue generating tools. All that is necessary is for the portal to link to a third party API to confirm that a transaction took place, and then that transaction can be used to generate points and revenue. Thus, any digitally measurable transaction may be linked to the portal and used to measure and verify that the transaction occurred, and then used by the platform to generate points and revenue.
2. Services can link to Portal through cloud servers, web services, et al.
3. Revenue Generating Tools can be an “opt-in” service for participants and/or pre-integrated into Portal.

Embodiments of Designated Revenue for Nonprofits may include without limitation:
1. Any revenue inserted into the portal for donative or commerce purposes that convert to a point/credit.
2. Any point/credit that is awarded a participant for purposes of giving to designated nonprofit of choice.
3. Any point/credit created that has a money value. Points/credits are generated between participants when an interaction occurs that produces revenue.

It is therefore an object of the present invention to provide systems, methods and apparatus for a new online marketplace platform.

It is a further object of the present invention to provide systems, methods and apparatus for producing a currency, which may be donative in nature.

It is a further object of the present invention to provide systems, methods and apparatus for distribution of revenues to nonprofits and others in need of funds through CGM.

It is a further object of the present invention to provide systems, methods and apparatus for distribution of revenues for rewards to participants from the interactions with other participants related to CGM.

It is a further object of the present invention to provide systems, methods and apparatus for a clearinghouse that exchanges monetary units for points/credits, which may be used for donative purposes.

It is a further object of the present invention to provide systems, methods and apparatus for a clearinghouse that exchanges monetary units for points/credits, which may be used for commerce purposes.

It is a further object of the present invention to provide systems, methods and apparatus for marketing that integrates the financial and social impact of consumers, merchants, and nonprofits through CGM.

It is a further object of the present invention to provide systems, methods and apparatus for determining and measuring the intentions of participants by the results of their interactions with other participants (Integrity Meter).

It is a further object of the present invention to provide systems, methods and apparatus for measuring the inter-connected “passive giving” of participants across linked revenue generating tools (e.g., a rewards card) and marketing tools (e.g., Social Impact Meter).

It is a further object of the present invention to provide systems, methods and apparatus for a CGM that produces a new method of “passive revenues for purposes of giving to causes” through Revenue Generating Tools linked to a Portal.

It is a further object of the present invention to provide systems, methods and apparatus to link one or more third party commerce services owned by a consumer with one or more merchants linked to Portal.

It is a further object of the present invention to provide systems, methods and apparatus for connecting merchants, consumers and nonprofits in order to affect their financial and social impact.

It is a further object of the present invention to provide systems, methods and apparatus for linking third party commerce services of a consumer with merchants linked to a portal.

It is a further object of the present invention to provide systems, methods and apparatus for applying “passive giving” to competitive events for social impact marketing

It is a further object of the present invention to provide systems, methods and apparatus for applying “passive giving” to competitive events for consumer rewards

Additional objects of the invention will be apparent from the detailed descriptions and the claims herein.

### BRIEF DESCRIPTIONS OF THE DRAWINGS

The drawing figures depict one or more implementations, aspects or embodiments in accord with the present concepts, by way of example only, not by way of limitations. In the figures, like reference numerals refer to the same or similar elements:

FIG. 1 is a block diagram representation of the Social Impact Marketing Platform, or the Portal, for producing a CGM.

FIG. 2 is a block diagram representation of one embodiment of the Portal for how Merchant Processors interact to market its social impact, drive merchants to the system, and generate revenue.

FIG. 3 is a block diagram representation of one embodiment of the Portal for how Merchants interact to market its social impact, interact with Revenue Generating Tools, and designate the nonprofit to receive revenues generated through the Portal.

FIG. 4 is a block diagram representation of one embodiment of the Portal for how Nonprofits interact to market its social impact, direct consumers to the Portal, and receive designated revenues for their organization.

FIG. 5 is a block diagram representation of one embodiment of the Portal for how Consumers interact to market its social impact, generate revenue for nonprofits, and designate the nonprofit to receive revenue generated through the Portal.

FIG. 6 is a block diagram representation of one embodiment of the Portal for how Financial Institutions interact to market its social impact, direct consumers to the Portal, and generate revenue.

FIG. 7 is a block diagram representation of a CGM, connected to the Portal, for how a consumer creates a Team to compete with another Team in a competitive event to generate revenue for a designated nonprofit.

FIG. 7.1 is a block diagram representation of an alternative embodiment of a CGM, connected to the Portal, for how a consumer uses a game board to generate revenue for a designated nonprofit.

FIG. 8 is a block diagram representation of one embodiment of the Portal for how the Administrative System interacts with a Cloud Network, 3rd Party APIs, and a Data Storage Device.

FIG. 9 is a block diagram representation of one embodiment of the Revenue Generating Tools of the Portal for how revenue is generated for Participants.

FIG. 10 is a block diagram representation of one embodiment of the Marketing Tools of the Portal for how a participant markets the revenue generated for a designated nonprofit and how other participants rate their values and actions.

FIG. 11 is a flow chart of an exemplary method for how the Checkout Button, a Revenue Generating Tool, interacts with Participants to generate revenue for Participants from online transactions and is marketed.

FIG. 12 is a flow chart of an exemplary method for how the In-Store Purchase, a Revenue Generating Tool, interacts with Participants to generate revenue for Participants from a terminal and is marketed.

FIG. 13 is a flow chart of an exemplary method for how the Browser Application, interacts with Participants to generate revenue for designated nonprofits from time spent online.

FIG. 14 is a flow chart of an exemplary method for how to generate a single shared value of a point to donate to nonprofits at any time.

FIG. 15 is a flow chart of an exemplary method for how the Portal is positioned in the marketplace for it to operate and function.

FIG. 16 is a block diagram of an exemplary home page for a participant to measure, verify, and market social impact.

FIG. 17 is a block diagram of an exemplary CGM for a consumer to create a team to compete against other teams, set a time length for the competition event, add participants, rate the collective social interactions of participants in the Integrity Meter, increase the collective revenue in the Social Impact Meter to benefit the designated nonprofit.

FIG. 18 is a visual example of an exemplary Browser Application for how participants advertise through the ad display, send messages through the News Feed, generate a point of monetary value from time spent online at no-out-of-pocket expense to the consumer, designate a nonprofit, and interact with the Portal and other social media.

FIG. 19 is a visual example of an exemplary Checkout Button and Social Impact Meter on the website of a participant.

FIG. 19.1 is a visual example of an exemplary Checkout Button Process to verify Participants and consumer purchase data.

FIG. 19.2 is a visual example of an exemplary Checkout Button Process to login, register, and designate a nonprofit to benefit at the point-of-sale.

FIG. 19.3 is a visual example of an exemplary Checkout Button Process to confirm and change the designated nonprofit of Participants.

FIG. 19.4 is a visual example of an exemplary Checkout Button Process to review and pay to generate revenue for the designated participant.

FIG. 19.5 is a visual example of an exemplary Checkout Button Process to measure, verify, and market the designated revenue for a nonprofit through a certificate for the Participant.

FIG. 20 is a flow chart of an exemplary method for how the Portal interact between consumers and merchants to produce initial revenues for passive giving.

FIG. 21 is a flow chart of an exemplary method for how the Portal interact between nonprofits and merchants to produce initial revenues for passive giving.

FIG. 22 is a block diagram of an exemplary embodiment of the Portal showing the relationships between consumers, nonprofits and merchants with respect to advertising, events, teams, and third party APIs.

FIG. 23 is an illustration of several exemplary building blocks that may or may not be used in embodiments of a Portal of the present invention.

FIG. 24 is a schematic representation of a distribution system for the free distribution of electronic media content to users.

FIG. 25 is a block diagram of one embodiment of a distribution system for the free distribution of electronic media content to users.

FIG. 26 is a block diagram of an exemplary login interface for a user to log into a distribution portal.

FIG. 27 is a block diagram of an exemplary display when a user has logged into a distribution portal.

FIG. 28 is a flow chart of an exemplary method for accruing and redeeming points in a points bank.

FIG. 29 is a flow chart of an exemplary method for accruing and redeeming points in a points bank.

### DETAILED DESCRIPTION

The present disclosure provides systems, methods and apparatuses for producing a CGM through a Social Impact Marketing Platform.

It is to be appreciated that although the figures and examples, and the discussions thereof below, refer to raising funds or revenues for nonprofits, that the figures, examples and discussions and the systems, methods and apparatuses of the present invention, may also be used for generating revenue or funding for things other than nonprofits, such as, without limitation, merchant products, product development, programs, particular proposals, ideas or other purposes or causes.

Several aspects of the embodiments described herein will be illustrated as software programs or components stored in a computing device. As used herein, a software program or component may include any type of computer instruction or computer executable code located within a memory device and/or transmitted as electronic signals over a system bus or network. A software program may, for instance, comprise one or more physical or logical blocks of computer instructions, which may be organized as a routine, program, object, component, data structure, etc., which performs one or more tasks or implements particular abstract data types.

In certain embodiments, a particular software program may comprise disparate instructions stored in different locations of a memory device, which together implement the described functionality of the program. Indeed, a program may comprise a single instruction, or many instructions, and may be distributed over several different code segments, among different programs, and across several memory devices. Some embodiments may be practiced in a gateway and/or clearinghouse computing environment where tasks are performed by a remote processing device linked through a communications network. In a gateway and/or clearinghouse computing environment, software programs may be located in local and/or remote memory storage devices.

The systems, methods and apparatuses of the present invention provide numerous ways of generating revenues for nonprofit organizations, or for other purposes or causes, which may be used collectively or independently. In one aspect of the invention, a merchant may designate a particular nonprofit organization as the recipient of a certain percentage of revenue generated that convert to a point through purchases by consumers who utilize some aspect of the Portal. The systems, methods and apparatuses of the present invention are capable of connecting merchants, merchant processors, nonprofits and consumers together facilitate accomplishment of such goals. In another aspect of the invention, a consumer may wish to transfer a certain amount of revenue (or transfer some other thing of value such as “frequent flyer points”) to a nonprofit through the consumer's usage of a credit card, debit card or the like. The systems, methods and apparatuses of the present invention are capable of connecting financial institutions and consumers together facilitate accomplishment of such goals. In another aspect of the invention, groups of consumers may form teams that collectively transfer a certain amount of revenue (or transfer some other thing of value such as “frequent flyer points”) to a nonprofit through participation in a competitive event. The systems, methods and apparatuses of the present invention are capable of setting up the teams, and connecting financial institutions and consumers together facilitate accomplishment of such goals. It is to be appreciated that the systems, methods and apparatuses of the present invention have many other aspects and may be used in many other ways for the benefit of nonprofits, or for any accumulation of revenues for any purpose or cause.

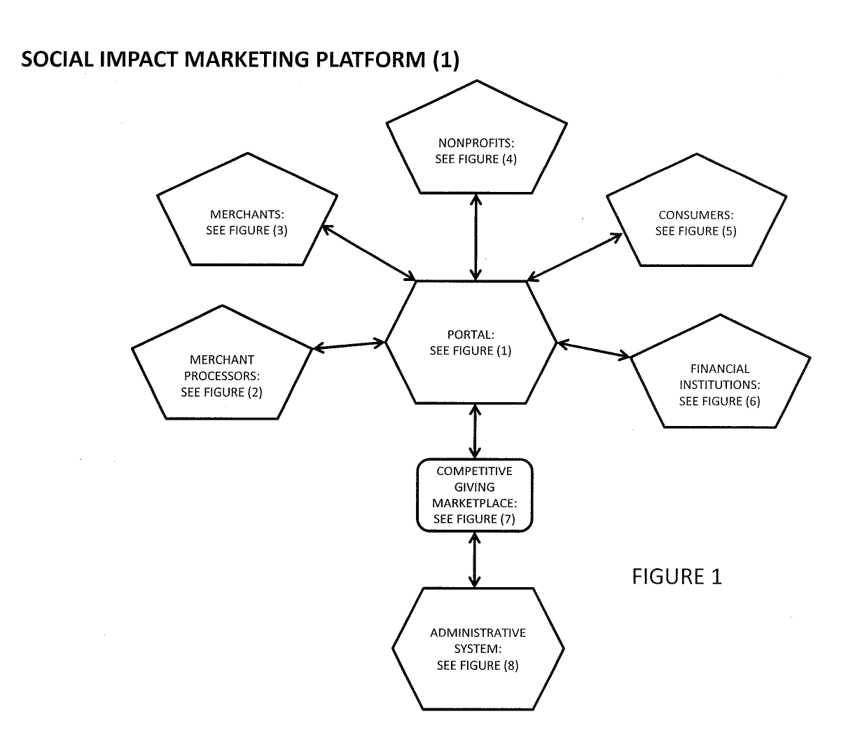

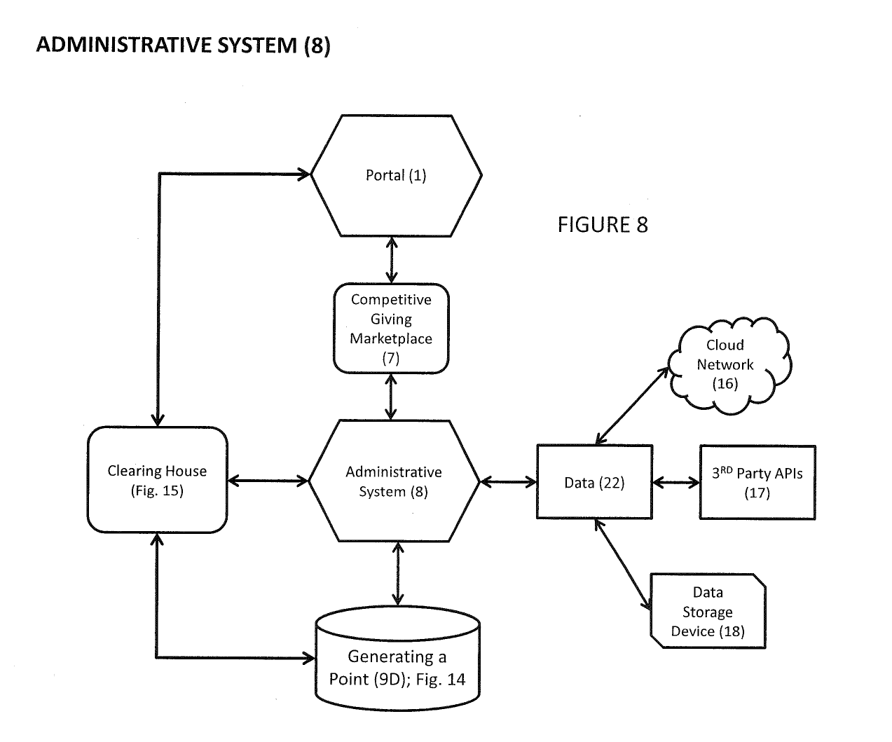

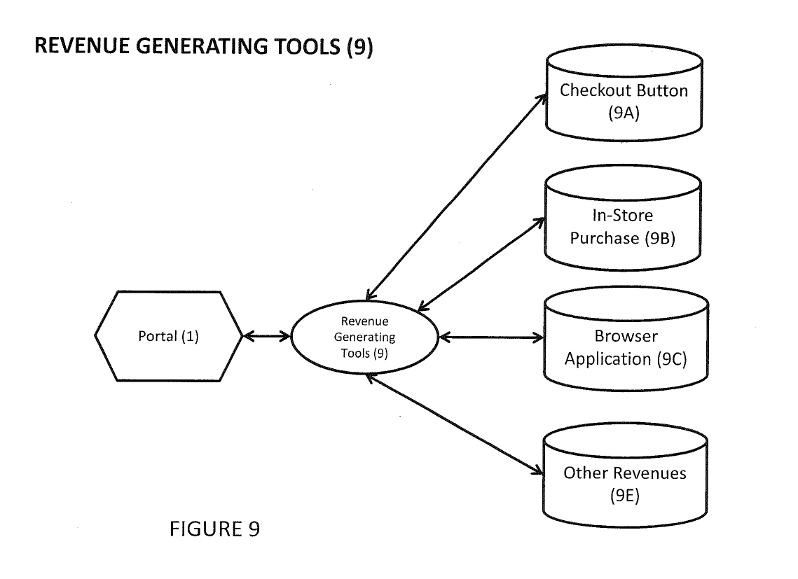

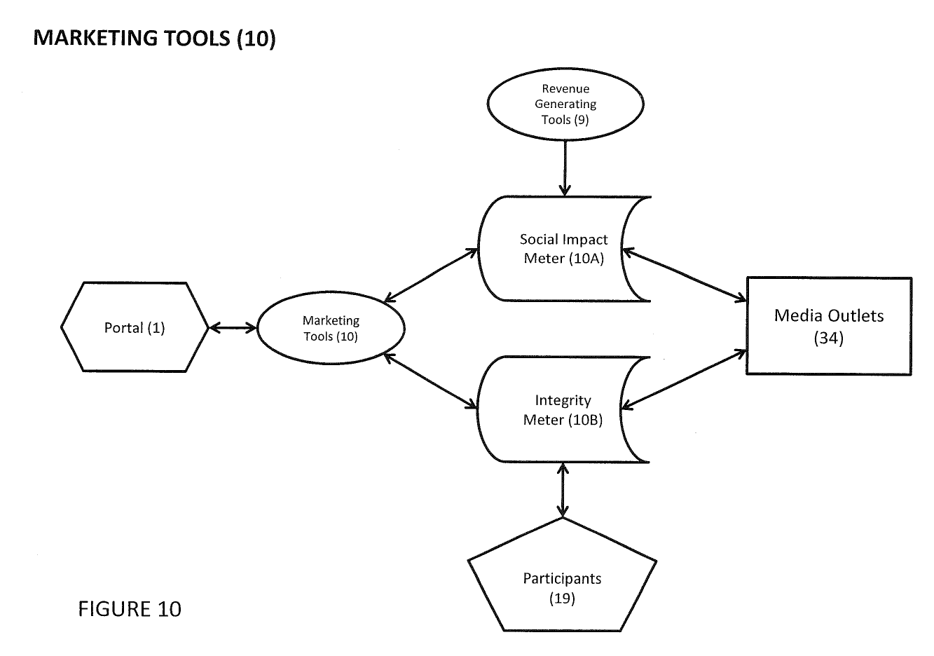

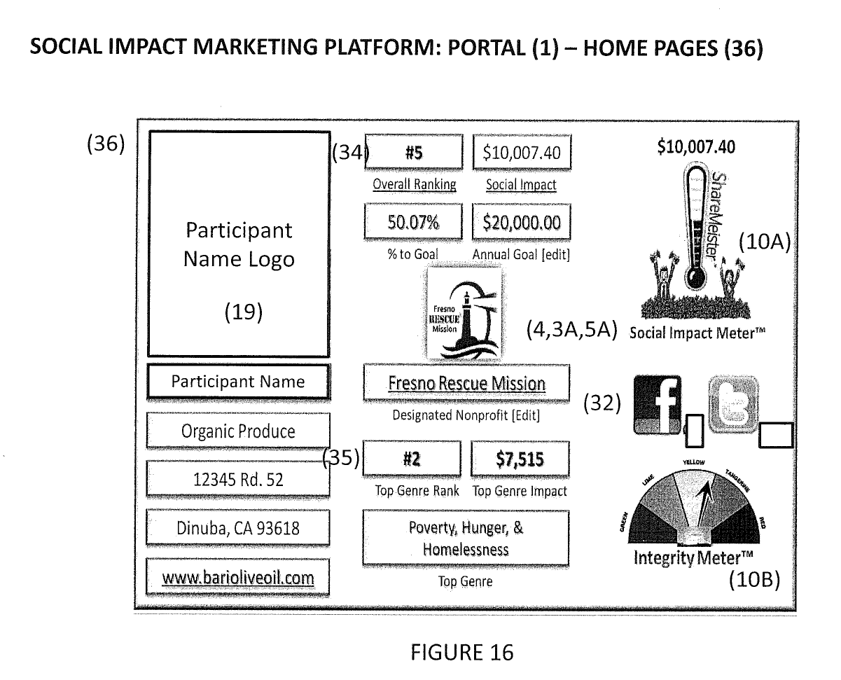

In accordance with the embodiments described in greater detail below, and as shown in FIG. 1, the systems, methods and apparatuses disclosed herein create a Competitive Giving Marketplace (CGM) 7 through a Social Impact Marketing Platform, or Portal 1. The Portal 1 interfaces with and connects merchant processors 2, merchants 3, nonprofits 4, consumers 5, financial institutions 6, who are sometimes referred to as participants 19. Participants 19 may have home pages 36 (see FIG. 16) that provide access to revenue generating tools 9 (see FIG. 9), and showcase marketing tools 10 (see FIG. 10). Revenue generating tools 9 may include, but are not limited to, a “checkout” button of a purchasing page from an internet website, an in-store purchase point, a browser application, an ATM machine, generation of a “point”, in-kind donations, quantified volunteering hours, gifts and the like. Showcase marketing tools 10 may include, but are not limited to, a Social Impact Meter, Integrity Meter, Participant Homepages, Billboard, and Data Analytic tools. The Portal 1 links participants 19 to a CGM 7 to maximize the potential giving of participants 19 through, for example, competition. The portal 1 and CGM 7 interacts with an administrative system 8 that processes the data 22 for display. See FIG. 8.

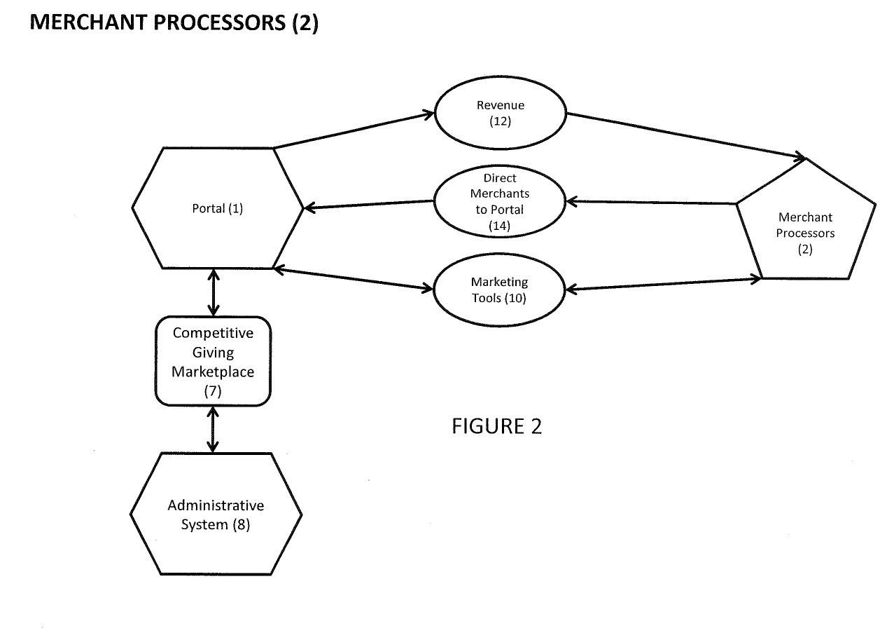

FIG. 2 is a representation of one embodiment or aspect of the Portal 1 from a merchant processor's perspective. Merchant processors 2 have access to marketing tools 10 (such as the Social Impact Meter) to measure, verify, and market the social impact (including, without limitation, the benefit received by a nonprofit, cause or purpose) of merchants 3 driven to the Portal 1 via an already existing business relationship. By way of example, and without limiting the claims herein, a merchant 3 may have an existing banking or credit card relationship with a merchant processor bank 2. Such a merchant 3 may be driven to the portal by this bank 2 because the bank 2 wishes to increase participation at the Portal. When a merchant 3 registers with the Portal, a merchant processor 2 is “declared” by the merchant 3 creating a link between the merchant 3, the merchant processor 4, and the Portal 1. As merchants 3 generate revenues from revenue generating tools 9, the collective designated revenue for nonprofits 11 of all merchants 3 connected to portal 1 and claiming that merchant processor 2 is measured, verified, and marketed in the marketing tools 9 already linked to the Portal for use by the merchant processor 2. This allows the particular merchant processor to display/disclose (market) the giving that it has been involved with. In exchange for directing merchants to the portal 14, revenue 12 is generated through revenue generating tools 9 and is distributed from the Portal 1 to the merchant processor 2. The ultimate distributions to the nonprofits are accomplished through a clearing house which is part of the Portal. It is to be appreciated that in some embodiments, a merchant may register and work directly through the Portal, but in other embodiments a merchant may register and work with a merchant processor and the Portal.

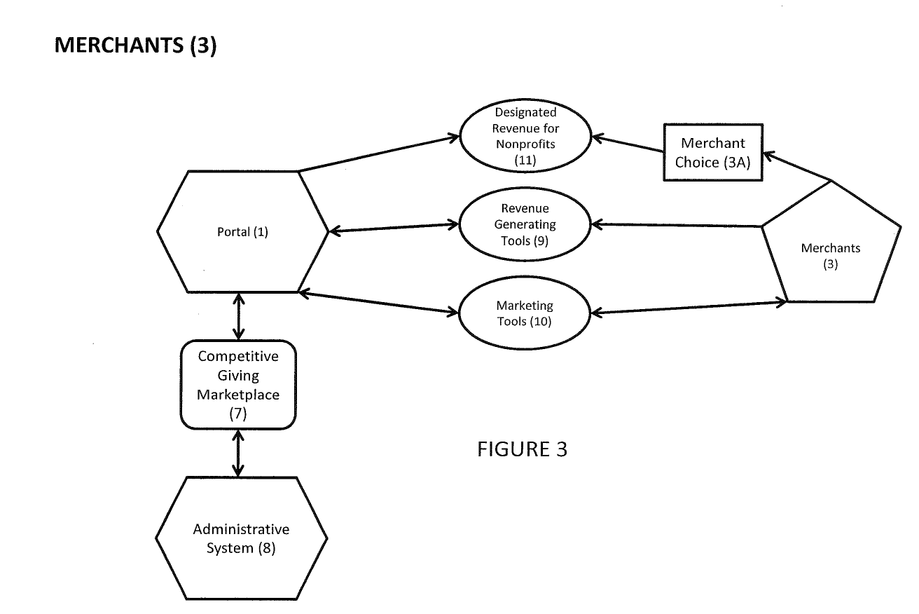

FIG. 3 is a representation of one embodiment or aspect of the portal 1 from a merchant's perspective. Merchants 3 use revenue generating tools 9 to market their social impact through marketing tools 10. Merchants are able to choose a designated nonprofit 3A, which will receive benefits when a consumer 5 interacts with the revenue generating tools 10 subscribed to by the merchant 3. In some embodiments, merchants may subscribe to a consumer option, which gives consumers 5 the freedom to override the designated nonprofit 4 of the merchant 3, and replace it with a different nonprofit 4 selected by the consumer 5. Merchants 3 generate revenue from the revenue generating tools 9 and designate a percentage of revenue per consumer 5 transaction to benefit nonprofits 4. Designated revenue to nonprofits 11 is measured, verified, and marketed through the marketing tools 10 and may be posted on the home page 36 of the merchant 3 to show the giving that it has been involved with. See FIG. 16.

By way of example, and without limiting the claims herein, a consumer 5 shopping on-line at the web site of a merchant 3 may see an advertisement and link on the merchant's web site that gives the consumer the opportunity to give to a designated nonprofit 4. This advertisement is one of the marketing tools 10 used by the merchant 3. Clicking on the link informs the consumer 5 of how (s)he may participate in giving to the nonprofit 4 that has been designated by the merchant 3. If the option is made available by the merchant, the consumer may select a different nonprofit 4 of its own choosing. The consumer 5 is then directed to the Portal 1 where (s)he registers and becomes a participant.

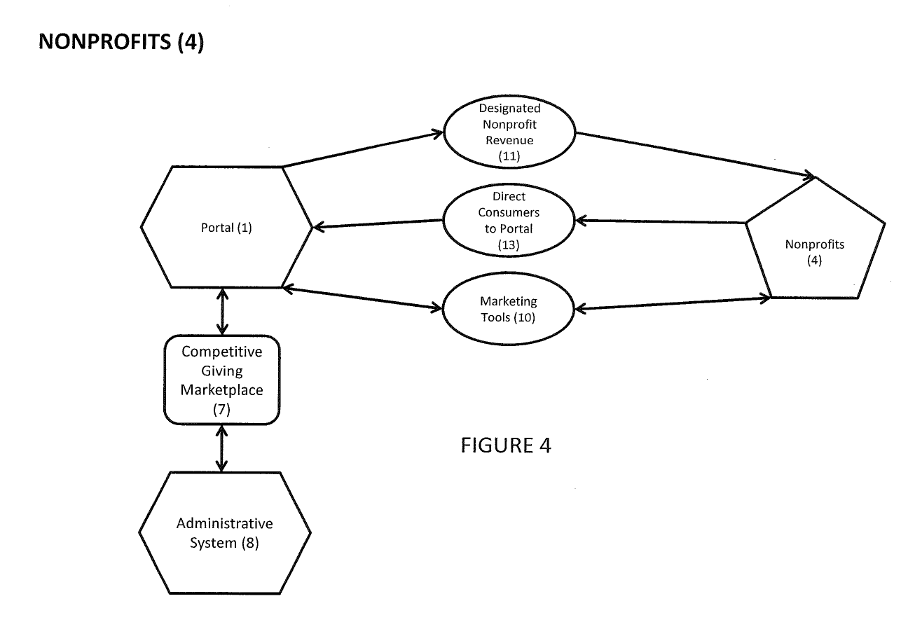

FIG. 4 is a representation of one embodiment or aspect of the Portal 1 from a nonprofit's perspective. Nonprofits 4 register at the Portal 1 and direct consumers 5 to the portal 13. Consumers 5 use the revenue generating tools 9 connected to the portal 1 and re-direct the revenue 12 to the nonprofit 4. For example, and without limitation, a consumer 5 may designate that all “reward points” generated by the consumer's credit card be converted into credits that are available to be given away by the consumer. The credits accumulated by this revenue generating tool remain in the account of a consumer until given away, such as, without limitation, through a competitive giving event. Designated nonprofit revenue 11 generated for nonprofits 4 by participants 19 from the revenue generating tools 9 connected to the Portal 1 is measured, verified, and marketed in the marketing tools 10 for use by the nonprofits 4. Accordingly, by way of example and without limitation, a nonprofit will receive information regarding the benefits that it has received through an event on the Portal, and may display that information on its web site to show the social impact that has been made, and potentially entice other consumers to register with the Portal and become part of the event.

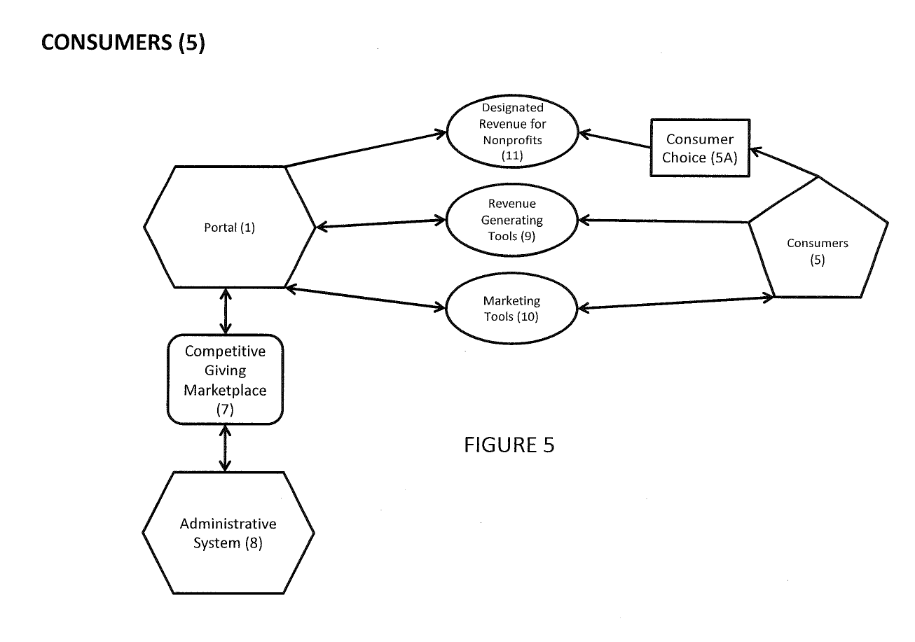

FIG. 5 is a representation of one embodiment of the portal 1 from a consumer's perspective. Consumers 5 register at the portal 1 and use revenue generating tools 9 to benefit nonprofits 4 they want to support. Consumer choice 5A is given to consumers 5 at the point-of-transaction, unless in certain instances, the merchant 3 has not given consumers 5 the option to do so. Designated revenue to nonprofits 11 is measured, verified, and marketed through the marketing tools 10 and posted on the home page 36 of the consumer 5. By way of example, and without limiting the claims herein, a consumer 5 may sign up through portal 1 by registering personal information on the landing page. The consumer then uses a revenue generating tool 9, in this example designating “reward points” from a credit card, to accumulate credits. Once the consumer has signed up, in this example, every time (s)he utilizes the particular credit card, then revenue or points are sent to a clearing house, awaiting his/her designation to which nonprofit the points/credits should be delivered.

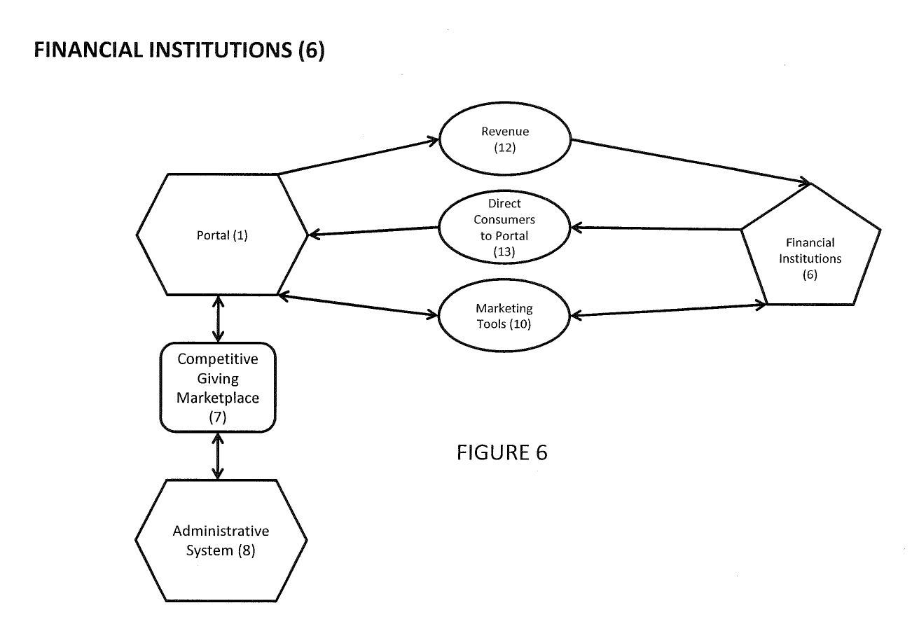

FIG. 6 is a representation of one embodiment of portal 1 from a financial institution's perspective Financial Institutions 6 have access to marketing tools 10 to measure, verify, and market the social impact of consumers 5 driven to the portal 1 via an already existing business relationship such as a credit card relationship with the financial institution. When consumers 5 register, the financial institution 6 is declared by the consumer 3 when linking their preferred debit or credit card 9B to the Portal 1. This creates a link between the consumer 5, the financial institution 6, and the Portal 1. As consumers 5 generate revenues from revenue generating tools 9, the collective designated revenue for nonprofits 11 of all consumers 5 connected to portal 1 and claiming that particular financial institution 6 is measured, verified, and marketed in the marketing tools 9 for use by that particular financial institution 6. In exchange for directing consumers to the portal 14, revenue 12 is generated through revenue generating tools 9 and is distributed from the portal 1 to the financial institution 6. By way of example, and without limiting the claims herein, when a consumer 5 registers through portal 1 (s)he automatically designates a financial institution when identifying a credit card for use in accumulating points for nonprofits. Once the consumer has signed up, in this example, every time (s)he uses the credit card, then revenue or points are accumulated in the clearing house to eventually be sent to a nonprofit.

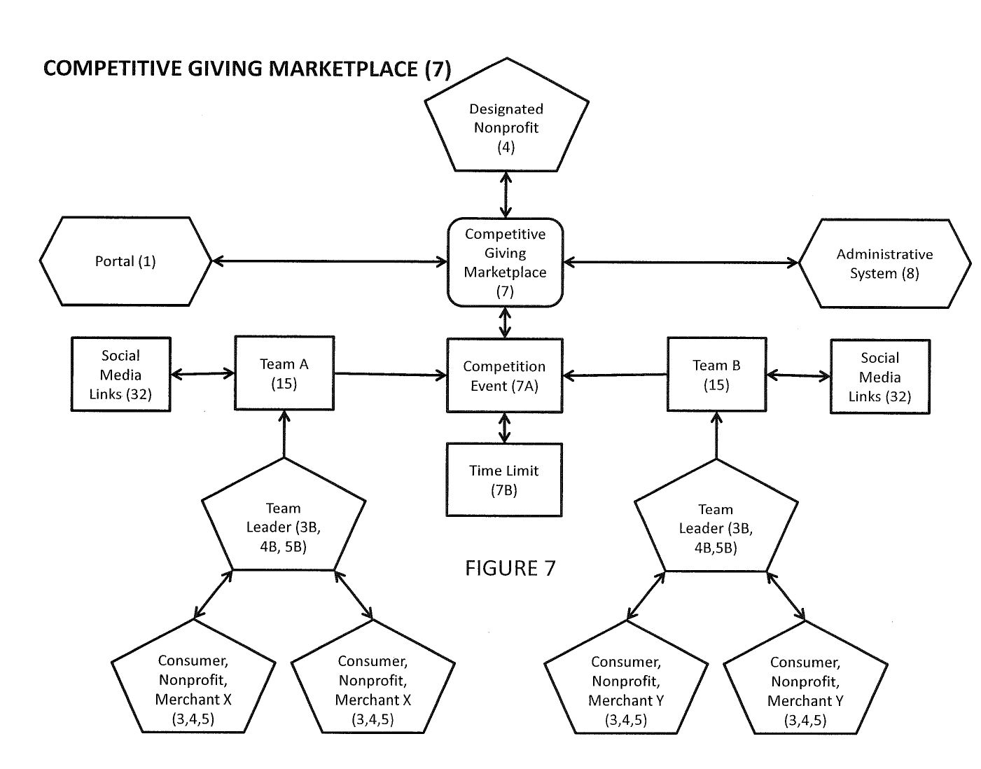

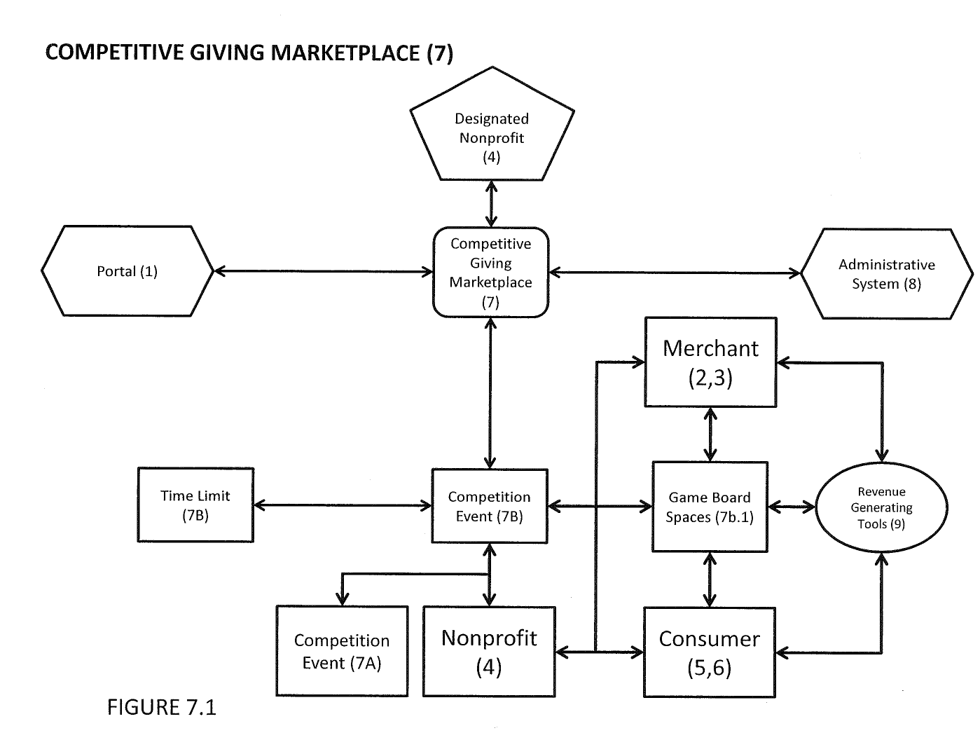

FIG. 7 is a representation of an exemplary CGM 7 connected to the Portal 1. Consumers 5 are able to become a team leader 5B by creating a team 15. A team 15 is able to compete with another team 15 in a competition event 7A. The team leaders 5B set a time limit 7B and a designated nonprofit 4 to benefit from the competition event 7A. A team 15 is able to add consumers 5 and merchants 3 to compete and increase the designated revenue for nonprofits 4. The competition event 7A may be connected to social media links 32 to raise awareness for the nonprofit 4.

By way of example, and without limiting the claims herein, an event 7A may be established by any participant, and a deadline or end date 7B for the event is designated. Then a first team A may be set up by any participant. Then a competitive team B is then set up by any participant. Once the teams are set up, consumers may join by selecting the team of their choice (they'll also be able select a nonprofit of choice linked to the Portal, if the administrator of the event gives them the option to do so). Then, whenever a team member donates direct cash or points/credits via a revenue generating tool 9 (automatically or manually) that causes revenue to be generated for one or more designated nonprofits. When the end date for the event arrives, the results of the event are posted and money raised for the nonprofit(s) is delivered and posted in respective Social Impact Meter of Participants as it applies to their respective giving. During the event, if the social media links 32 are used, these may provide ways to market the Competitive Event and the giving/social impact of Participants, which may encourage other participants to join. Additional revenue may be generated by such things as, without limitation, donating direct cash, adding more members to the team, more engagements with the event, etc.—anything that generates a point/credit. It is to be appreciated that an unlimited number of teams may be established, and that each event may be customized for particular purposes.

FIG. 7.1 illustrates another exemplary implementation of a competitive event using a virtual game board. Each space on the game board may represent an objective to complete relating to a “marketing tool” a “revenue-generating tool” or the like, that is linked to the Portal. For example, a space may represent a particular merchant. The game board may consist of one or many merchant stores (spaces) where the purpose of each consumer is to shop at the store; where the merchant agrees to give a portion of each captured transaction, via device linked to portal, to a designated nonprofit, purpose or cause. When the consumer purchases from each merchant representing a space on the board, the consumer wins a reward AND generates desired revenue for a nonprofit, purpose or cause. Revenue designated for a nonprofit, purpose, or cause are converted into a point via the clearinghouse and distributed accordingly. Participants may or may not race against other participants around the board, to see who completes the challenge first. If a “race” is set up, a “prize” may be established by a merchant sponsor and provided to the “winner”. Participants may also customize the game board.

FIG. 8 is a representation of one embodiment of the Portal 1 from the administrative perspective. The administrative system 8 interacts with the data 22 flowing throughout the Portal 1. As necessary, it communicates with the cloud network 16, 3rd party application programming interfaces (APIs) 17, and/or data storage devices 18 to produce, store, and retrieve information to ensure an efficient system. The embodiment of FIG. 8 may further comprise one or more computing devices 17 (such as a computer, server or the like) and/or storage devices 18 (such as a database, hard drive, file server or the like) as necessary for implementing the functionality of the system.

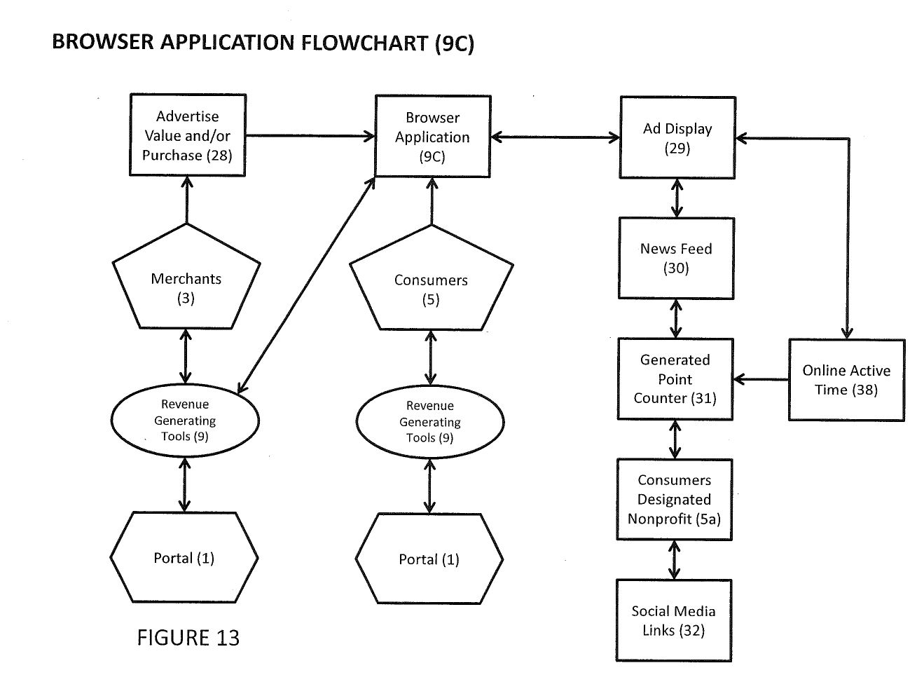

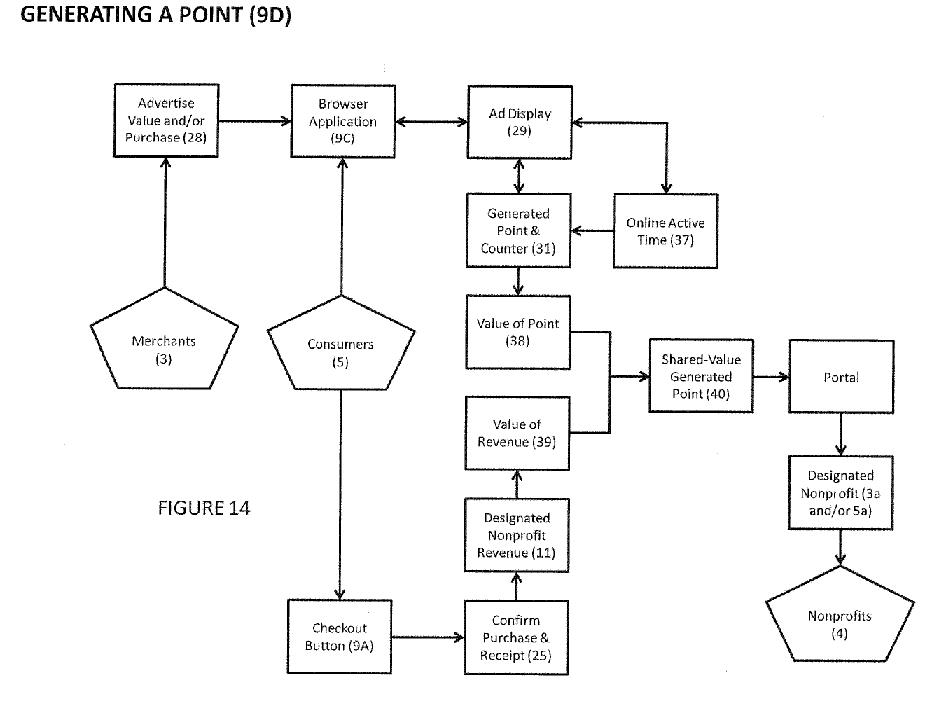

FIG. 9 is a non-exclusive list of some revenue generating tools 9 that may be used with the Portal 1. By way of example, and without limiting the claims herein, some revenue generating tools that may be 9 linked to the portal 1 include checkout buttons 9A, in-store purchases 9B (debit/credit/reward card), browser applications 9C, and generating points 9D. Other revenue generating tools may include, without limitation, Point-of-Sale service, E-commerce website, Gateway, Financial Institution, Reward Card, Credit/Debit interchange, Pre-paid card, Advertising platform, Marketing platform, Text service, Survey Platform, Data collection, Fees, or any technology or service that can be measured, or measures an exchange or transaction between two parties. (See discussion of FIGS. 13 and 14 for how a point is generated.) Additionally, other revenues 9E, such as in-kind donations, quantified volunteering hours, and gifts, can be linked to the Portal 1 to be measured, verified, and marketed through the marketing tools 10. By way of example, and without limitation, as mentioned previously, one revenue generating tool 9 is a consumer registering a rewards card to the Portal so that whenever that card is used, any “reward points” are converted into a point for donative purposes and accumulated in the consumer's account. These credits are then available to the consumer 5 to give to a nonprofit 4 or other purpose or cause either directly, through a competitive giving event, or the like. It is to be appreciated that other tools for generating revenue or points are within the scope of these tools 9.

FIG. 10 is a non-exclusive list of some marketing tools 10 that may be used with the Portal 1. The marketing tools 10 include, without limitation, a social impact meter 10A and an integrity meter 10B. Designated revenue 11 for nonprofits 4 created from the revenue generating tools 9 are measured, verified, and marketed by way of, for example, the social impact meter 10A, which may be placed onto the participant home page 36. See FIG. 16. Participants 19 are able to interact and rate other participants 19 through the integrity meter 10B, which may also be placed onto the participant home page 36 to promote accountability. The social impact meter 10A, which measures the giving by consumers/merchants and the receiving by nonprofits, and the integrity meter 10B may be posted on any media outlet 34 including, but not limited to competitive events, social media, television, commercials, feature-film, and participant websites 20.

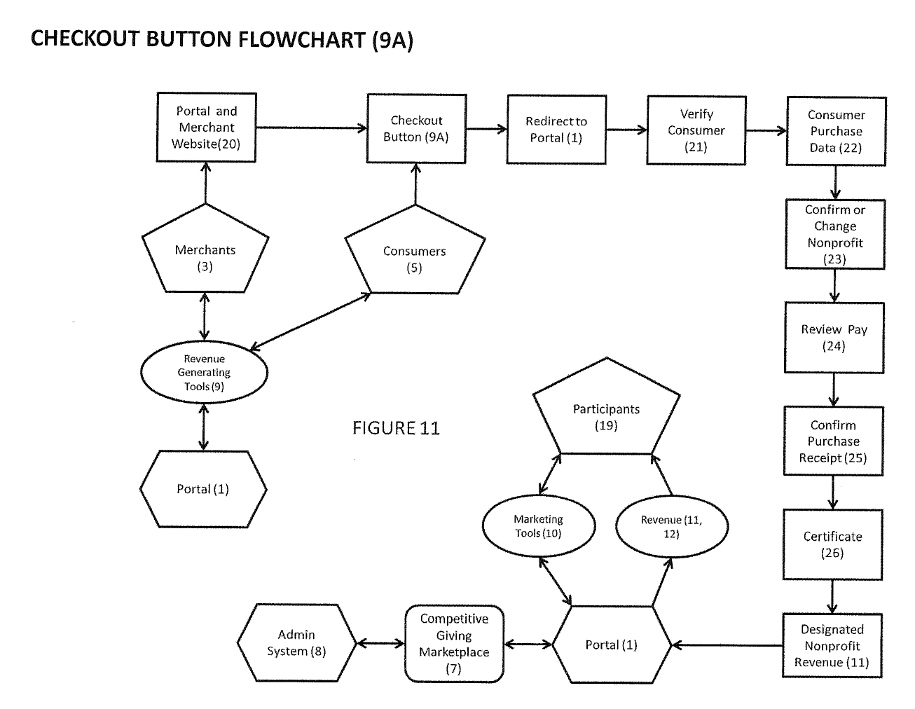

FIG. 11 is a flow chart depicting an exemplary embodiment in which a merchant 3 places a checkout button 9A from the revenue generating tools 9 of the Portal 1 on a website 20 and a consumer 5 makes a purchase 25 to benefit a designated nonprofit 4. At the point of online purchase, a consumer 5 clicks on the checkout button 9A and is redirected to the Portal 1 to verify the consumer 21, register and/or login, and confirm consumer purchase data 22 relayed from the merchant website 20. Of course, the consumer may decline to participate, and be returned to the checkout to complete his/her purchase transaction without logging in to the Portal. If the consumer wishes to participate, (s)he may confine or change the designated nonprofit 23, provided the merchant 3 has given the consumer 5 approval to do so. The consumer 5 reviews their cart and pays 24 producing a confirm purchase option and receipt 25. Upon completing the transaction through the checkout button 9A connected to the Portal 1, the consumer 5 is presented with a certificate 26 praising the social impact of their purchase and the nonprofit 4 receiving the revenue 11. The revenue 12 of the purchase is directed to the Portal 1, where it is separated and faunally directed to the participants 19, and the appropriate revenues measured, verified, and marketed in the marketing tools 10. The funds are represented in the consumer's account on the Portal, and thereafter released to the nonprofit within a reasonable time (e.g. 30-90 days), to allow for collection and processing, depending on where the funds originate). A direct cash donation may move more quickly than donations being paid by merchants By way of example, if a participant is connected to a team 15, the designated nonprofit revenue 11 from the consumer purchase 25 may be posted to the social impact meter 10A and added to the total of the team 15, and eventually distributed to the nonprofit at the end of the event or within a reasonable time thereafter. The data 36 is stored in the administrative system 8.

It is to be appreciated that the embodiment of FIG. 11 is only an illustration of an example, and that other compatible services, devices and/or applications may be connected to the Portal 1 to have the same effect as the checkout button 9A.

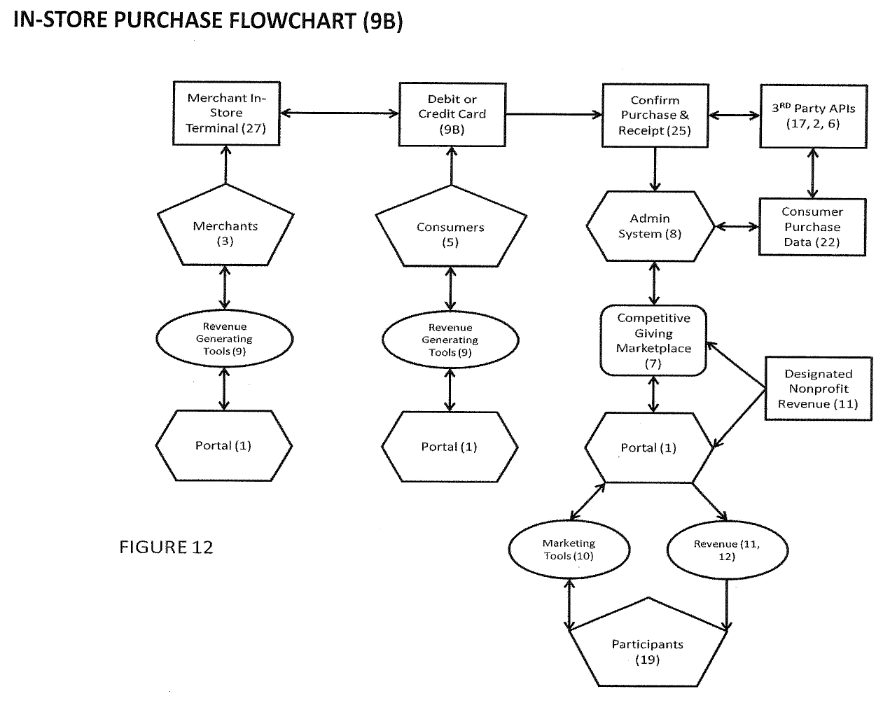

FIG. 12 is a flow chart depicting an exemplary embodiment in which a merchant links an in-store terminal 27 to un-registered or non-linked debit and/or credit cards 9B of consumers 5. To do so, the merchant 3 enters in their terminal identification 28, name of merchant processor 2, payment information 6, 9B, and agree to terms of service at the portal 1. Read-only transaction data 22 is provided to the portal 1 via a third-party service 18, connecting to the administrative system 8 and providing transactional data 22 to know when a consumer 5 makes an in-store purchase 27 from a merchant 5 connected to the Portal 1. The total amount of in-store purchases 27 are tallied monthly and a single payment is deducted via the payment information provided by the merchant 5 stored in the administrative system 8. In the scenarios of FIG. 12, the consumer 5 has not registered, and the merchant 3 has full discretion on the direction of giving generated by the transactions.

At the point of in-store purchase 27, a consumer 5 uses the debit and/or credit card 9B to complete a purchase 25 through a terminal 27. The embodiment of FIG. 12 further allows a consumer 5 the opportunity to register a debit, credit card, mobile wallet, etc., give the information provided on the card, provide the user name and password of the issuing financial institution, and agree that the portal is able to link with a 3rd Party API 17 or other service (2, 6), to retrieve the data from consumer purchase 25. The designated nonprofit revenue 11 created from the in-store purchase is measured, verified, and marketed through the marketing tools 10 and revenues (11, 12) are directed to the appropriate participants. Participants 19 engaged in a competitive event 7A may thereby increase the team's 15 social impact meter 10A total.

It is to be appreciated that the embodiment of FIG. 12 is not limited to in-store transactions by a consumer 5 through a merchant terminal 27 using debit and/or credit cards 9B, and may include in any medium of transaction that connects to the revenue generating tools 9 of the portal 1. All that is necessary is for the portal to link to a third party API to confirm that a transaction took place, and then that transaction can be used by embodiments of the invention to generate points and revenue. Thus, any digitally measurable transaction may be linked to the Portal 1 and used to measure and verify that the transaction occurred, and then applied by embodiments of the invention to generate points and revenue.

In addition, the embodiments of FIG. 12 may also allow consumers 5 the option to “round-up” their purchase total to the nearest whole number (e.g. $1.00) and direct the revenue 11 to nonprofits 4. The process requires consumers 5 to register a debit and/or credit card to the portal 1, name the issuing financial institution (e.g. bank, credit union, credit card company), and enter their login name and password of the online portal of the issuing financial institution. The portal links to a third-party service to access the consumer purchase data 22 to round up consumer purchases on a periodic (e.g. monthly) basis. At the close of every period (month), the Portal 1 deducts the amount from the consumer 5 and directs it to the designated nonprofit 4.

The embodiments of FIGS. 11 and 12 may also allow the merchants 3 to determine a percentage of designated nonprofit revenue 11 per consumer purchase 25, up to a specified amount, prior to the transaction event. Merchants 3 may, for example, designate two separate percentages of designated nonprofit revenue 11 per transaction: one for online purchases via a checkout button 9A on merchant websites 20, and another for purchases 9B from in-store terminals 27. The designated revenue percentage per consumer purchase 25 is measured, verified, and marketed through the marketing tools 10.

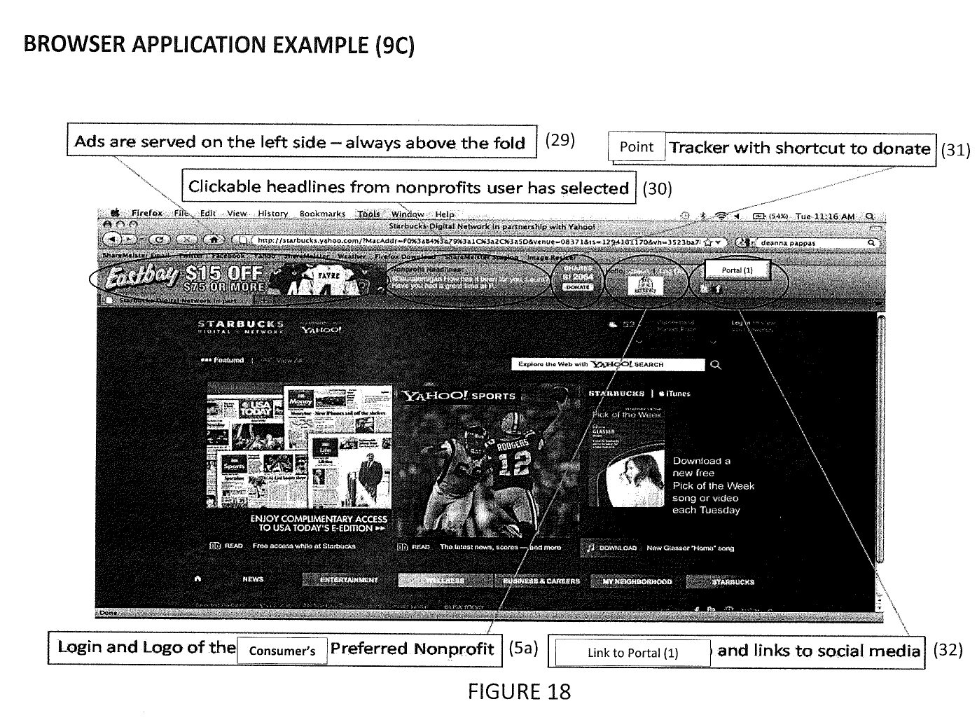

FIG. 13 is a flow chart depicting an exemplary embodiment in which a consumer 5 uses a piece of online technology, such as a browser application 9C, to generate revenue for nonprofits 11. The browser application consists of an ad display 29, which is used by participants for marketing. The news feed 30 is a tool used by participants 19, for example nonprofits 4, to spread text information with links to other websites 20 to consumers 5. See FIG. 18. A point counter 31 awards and tabulates points that can be donated to nonprofits 4. The value of points may be determined, for example, by the total advertising value 28, divided by total online active time 37 of the ad display 29 of a consumer 5. In this example, the advertising value 28 may be varied by the merchant depending on such things as what is being advertised, when the ad display is being viewed, etc. A link and logo may be provided on the browser application of the consumer's designated nonprofit 5A, along with links to social media 32.

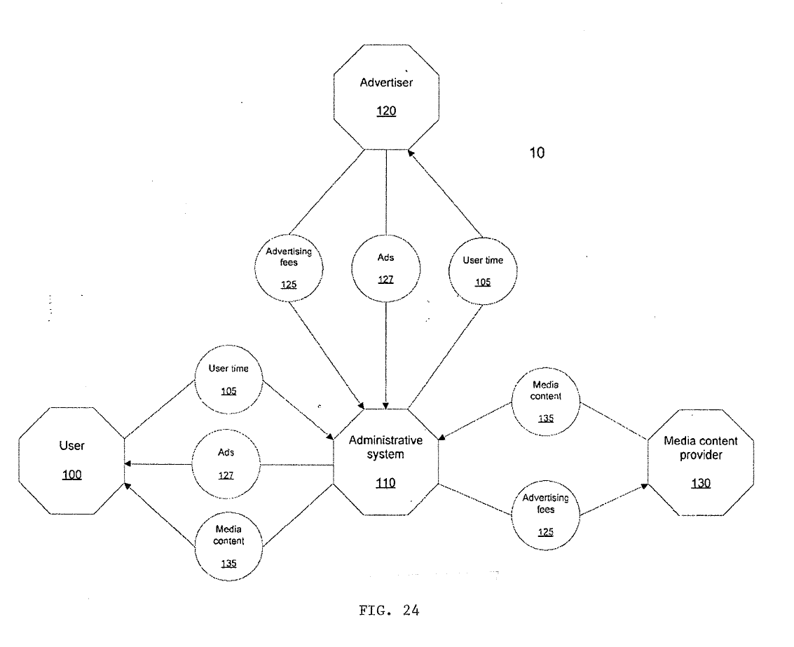

In exemplary embodiments such as that of FIG. 13, consumers may be able to generate a point based upon the total active time on the web, where active time refers to timed mouse movement or consecutive key strokes within a particular interval. The total online active time 37 may be divided by the total value of the advertising 28 generating a value for every generated point 31. See discussion of Systems and Methods for Distributing Electronic Media below, and FIGS. 24-29. Consumers 5 are able to donate each point 31 to nonprofits 4 which is converted to a specific monetary value that is measured, verified, and marketed through the marketing tools 10. Participants 19 that advertise 28 in the ad display 29 through the browser application 9C may count the monetary value equated to the point to the marketing tools 10.

FIG. 14 is a flow chart of an exemplary method for how to generate a shared-value point 40 using the value of points 38 with the value of revenue 39 to be saved, stored, and distributed to nonprofits 4 at the convenience of the consumer 5 and/or merchant 3. The value of a point 38 may be determined by, for example, the amount of time a consumer spends on the Internet while a banner advertisement is displayed to the consumer. The value of revenue 39 may be determined by, for example, the total amount of revenue generated over a designated period from purchase made by all consumers 5 who spent time on the Internet while a banner ad was displayed to them. These two values 38, 39 are then used to determine the shared value of a generated point 40. The shared value 40 may be a dynamic value, and may change over time. For example, if more consumers spend more time on the Internet and more purchases are made, then the additional time and the additional purchases may be taken into account to revalue the point 40.

In some embodiments, a generated point 40 may produce additional nonprofit revenue 11 for consumers 5 as it is allowed to rotate inside the portal 1 collecting interest, like a currency. The value of the stored point may be claimed at any time and directed to nonprofits 4, who may convert the point into a desired currency through the portal 1 or save up the donated points. It is to be appreciated that since the value of the point 40 may be constantly changing, the timing of this transaction (when the point is converted to currency and paid to the nonprofit) is important to maximize that value.

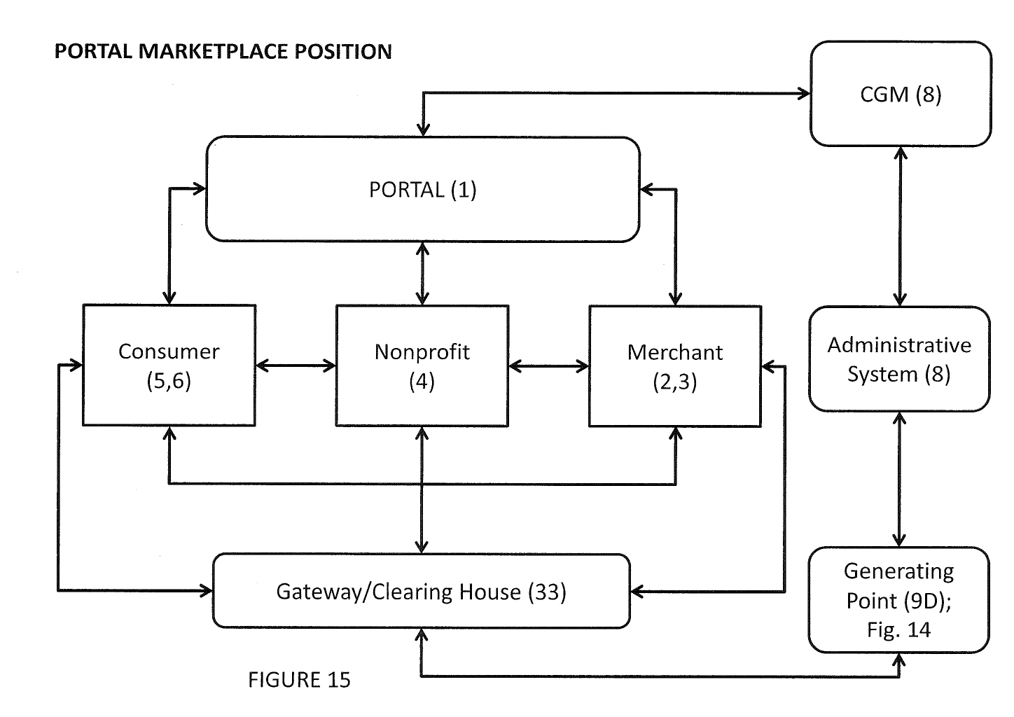

FIG. 15 is a flow chart of an exemplary method for how the Portal 1 is positioned in the marketplace in order to operate and function. The Portal 1 interacts with Financial Institutions 5 (e.g. Bank) that primarily drive consumers 5 to the Portal 1, and Merchant Processors 2 (e.g. Payment Processor) that primarily drive merchants 3 to the Portal 1. For example, and without limitation, revenue 12 is made through consumer purchases 25 between consumers 5 and merchants 3 in the online checkout button 9A (FIG. 11). A portion of revenue is re-directed to the Financial Institutions 5 and Merchant Processors 3 per consumer purchases 25, as required under standard credit card issuing agreements. Known systems, such as Visa and MasterCard, serve as Gateway and/or Clearing House systems 33 for processing transactions in conjunction with the Portal 1.

The embodiment of FIG. 15 further comprises that the portal 1 serves as a Clearing House (Gateway) 33 for processing transactions that redirects a portion of revenues to a nonprofit 4 as designated by merchants 3 and/or consumers 5 for marketing purposes. Clearinghouse 33 facilitates conversion of the value of points 38 generated from the browser application 9C with the value of the designated nonprofit revenue 39 from consumer purchases 25 connected to the portal 1 into a shared-value generated point 40, and facilitates the redemption of generated points 31, 40 generated from the browser application 9C or other points (e.g. currencies) connected to the portal 1 that are donated to nonprofits 4, and is not limited to the use of generated points 31, 40 for consumer goods and services.

FIG. 16 is a block diagram of an exemplary display of a home page 36 of the Portal 1. It is to be appreciated that different home page formats may be used by different participants (consumers, merchants, nonprofits) depending upon what information the participant wishes to display and how to display it. It is to be appreciated that in some embodiments, consumer participants may have the option of keeping their identities or giving information private. In these embodiments, the consumer decides whether or not others visiting the Portal will be allowed to see the consumer's page, to see them amounts given by that consumer, or to see the identities of those receiving those amounts. In other embodiments, consumers may link their Portal home page to their own social media page so that others may see their giving; and merchants may link their Portal home page to their commercial web site for similar marketing reasons.

Participants 19 sign up at the portal 1, provide basic information, pre-determine a percentage of sales to benefit nonprofits from each consumer purchase 25, and then designate a nonprofit 4, 3A, 5A to benefit from the social impact revenue generated 11. Participants 19 are ranked 34, 35 against other participants 19 and may join competition events 7A to drive the CGM 7. Marketing tools such as 10, 10A, 10B promote and compare the social impact of participants on any social media platform 32 and on the home pages 36 of the portal 1.

The embodiment of FIG. 16 may comprise a social impact meter 10A that measures the quantity of the social impact revenue designated for nonprofits by merchants 3 and consumers 5 at the point-of-sale. Nonprofits 4 have access to a social impact meter 10A that measures the amount of revenue received. Merchant Processors 2 and Financial Institutions 6 have access to a social impact meter 10A that combines the total social impact revenue 11 of merchants 3 claiming the Merchant Processor 2 connected to the portal 1 and total social impact revenue 11 of consumers 5 claiming the Financial Institution connected to the portal.

Each revenue generating service 9 connected to the portal 1 may be measured, verified, and marketed through the social impact meter 10A.

The embodiment of FIG. 16 may also comprise an integrity meter 10B that measures the quality of the relationship between participants 19. It is a crowd-sourcing tool to measure the authenticity of participants 19 and keep them accountable in their daily business dealings connected to, and not connected to, the portal 1. For example, and without limitation, when a consumer purchase 25 is made and a product is delivered by a merchant 3 to a consumer 5, that transaction benefits a nonprofit 4. The merchant 3, consumer 5, and nonprofit 4 can comment about their experience on the integrity meter 10B. For example and without limitation, such comments may be positive, negative or neutral resulting in an accumulated score that is also positive, negative or neutral. The integrity meter 10B provides a reference point for the quality of each social impact participant 19.

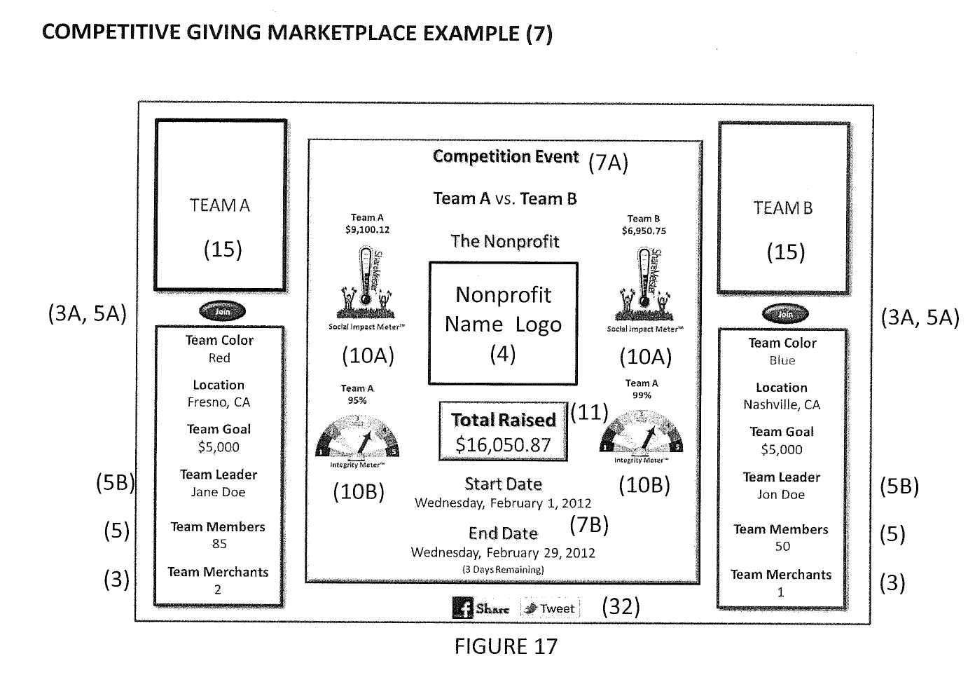

FIG. 17 is a block diagram of an exemplary display of a competition event 7A inside a CGM 7. A CGM 7 consists of multiple competition events 7A ranked and promoted in the portal 1. Consumers 5 may create a team 15 to maximize the benefit for a nonprofit 4. Teams 15 are created by a consumer 5, who becomes the team leader 5B. The team leader selects team name, team color and/or image, designated nonprofit, team origin zip code, revenue goal, able to accept/reject consumers and merchants wanting to join the team, and agrees to terms of service.

In these embodiments, teams 15 are able to connect with other teams 15 to start a competition event 7A. Team leaders 5B are able to send a competition notice to another team. The competition notice sets the duration of the event 7B, confirms the nonprofit to benefit 4, determines if merchants 3 are able to join the team 15, and teams 15 agree to terms of service. Team leaders 15 may reject the notice, or accept the notice to begin the competition event 7A. If the notice is rejected, then different terms may be proposed back and forth until an agreement is reached as to the ground rules for the competitive event.

In these embodiments, consumers 5 and Merchants 3 are encouraged to join (3A, 5A) a team 15 and generate revenue for the designated nonprofit 11. The collective social impact of participants 19 for each team are tabulated in the social impact meter 10A and integrity meter 10B for each team. The team 15 to raise generate the most money for the designated nonprofits 11 wins. The competition event 7A can be posted through social media 32 to generate awareness and increase the size of the teams 15, thereby potentially increasing the generation of revenue.

FIG. 18 is a visual example of an exemplary Browser Application showing one way in which participants may generate revenue for nonprofits 11. The portal 1 connects to an advertising-based Internet service enabling its consumers 5 to monetize the time they spend online 37. The system is simple and straightforward. Consumers 5 sign up at the portal 1 and download a software browser application 9C that affixes itself to the base of a browser, much like a toolbar. The browser application 9C travels with consumers 5 as they navigate the Internet. The portal 1 serves advertisements in time-based increments to the ad display 29, and preferably displays ads above the fold of a page with no scrolling. The portal rewards consumers 5 with value for their time spent online 37 utilizing the browser application 9C by passing all and/or a portion of advertising revenue 28 to consumers 4 in the form of a virtual currency, or points 31. Participants 19 may send messages through the news feed 30, such as, clickable headlines from nonprofits 4 the consumers 5 have selected. Consumers may designate a preferred nonprofit 5A to display in the browser application 9C and link to social media 32 and the portal 1.

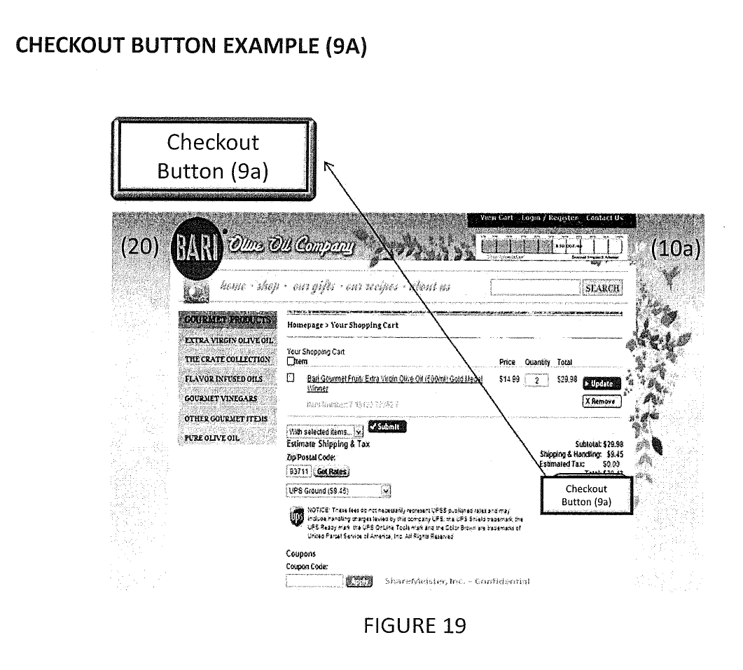

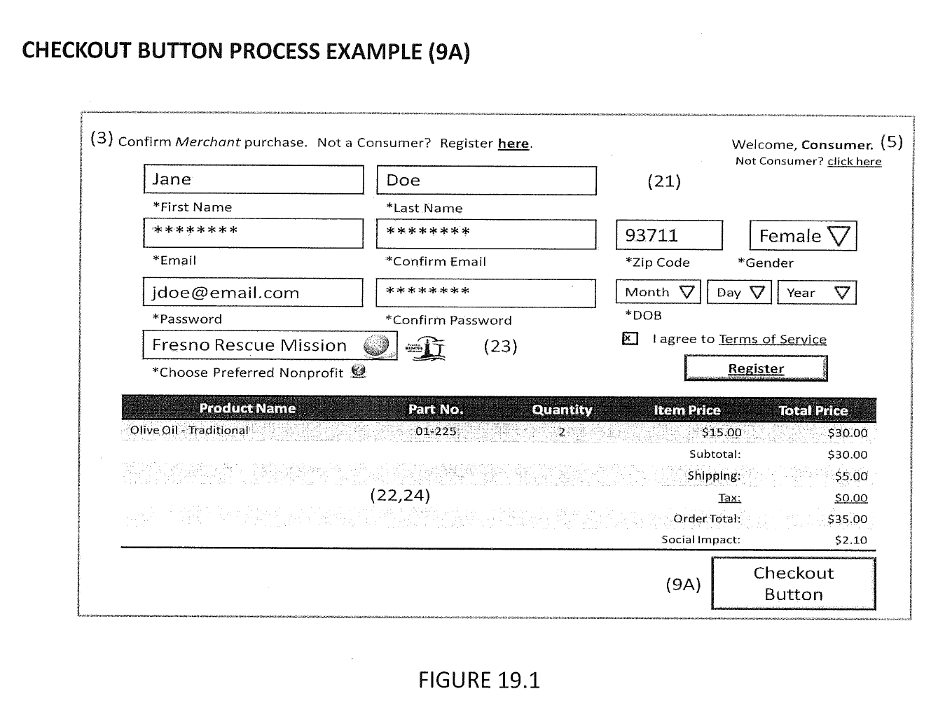

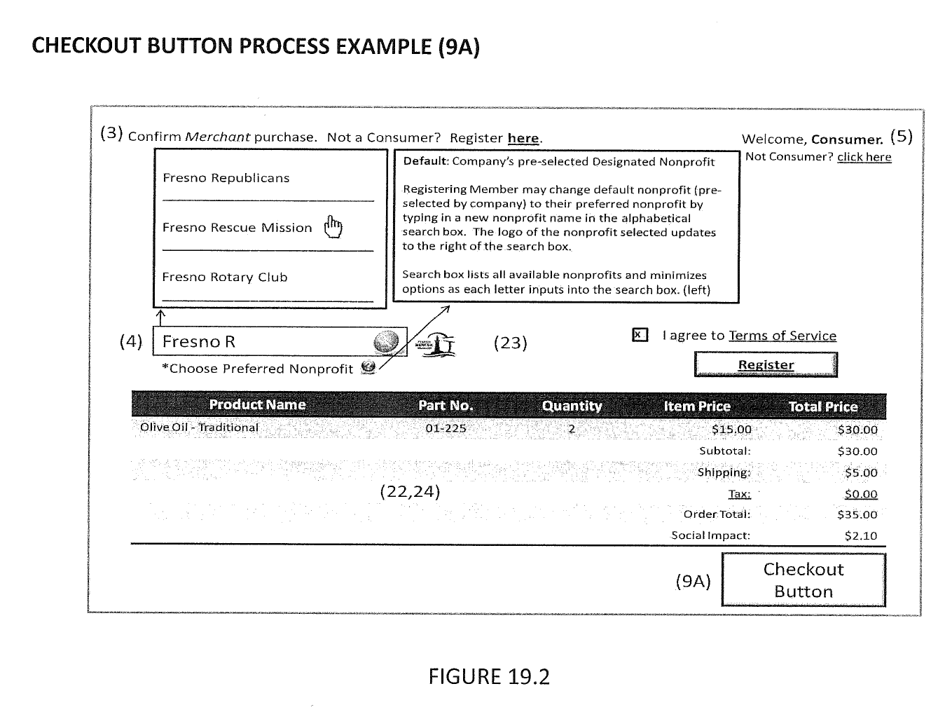

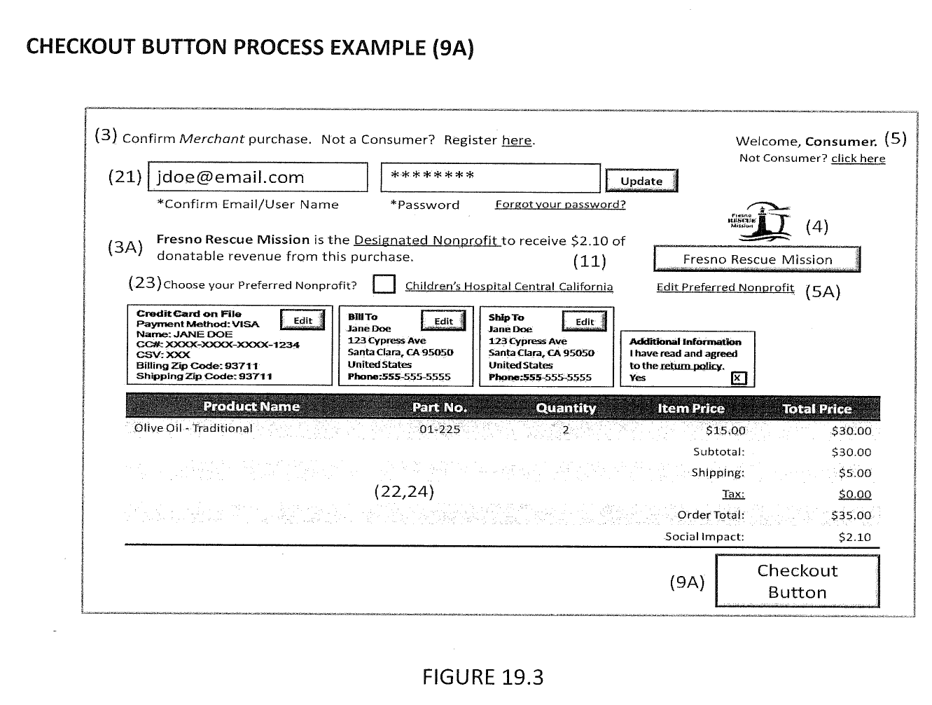

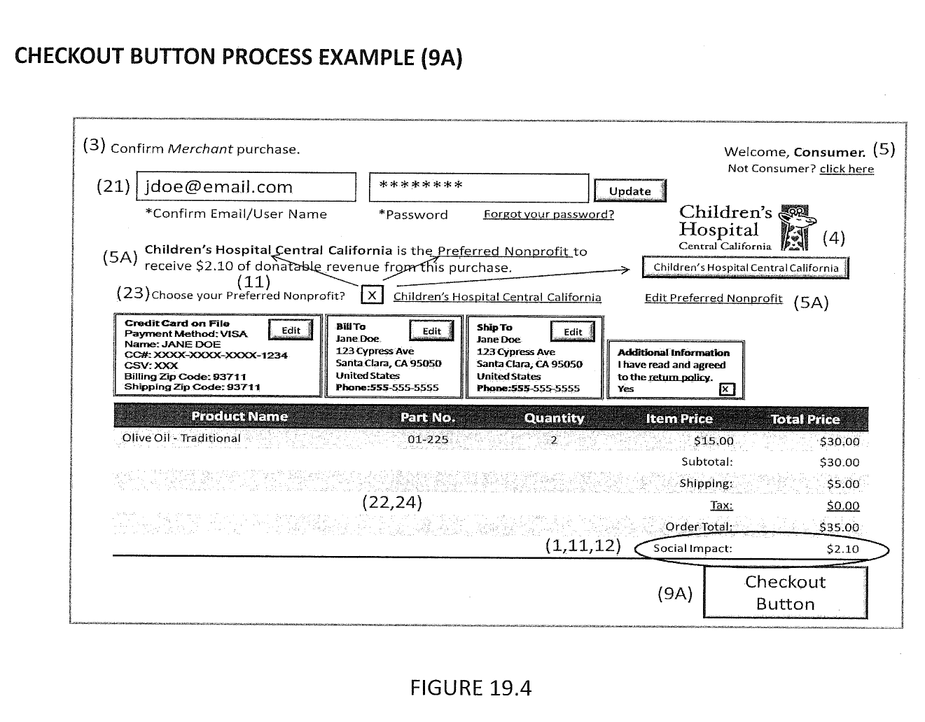

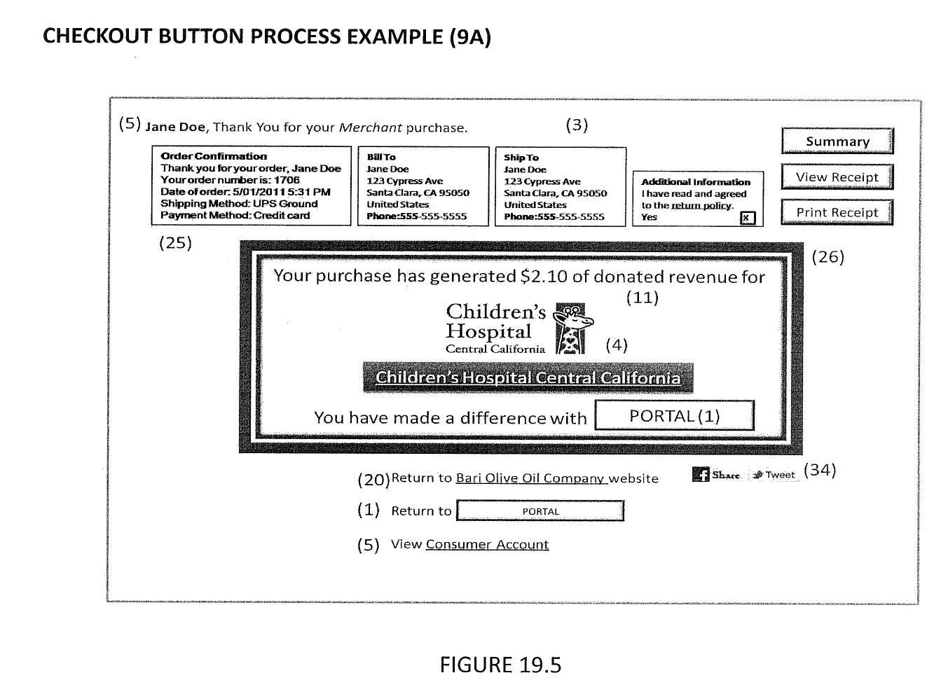

FIG. 19 is a visual example of an exemplary checkout button 9A and a social impact meter 10A on a merchant website 20. Consumers 5 proceed through checkout as normal and click on the checkout button 9A to generate revenue for a nonprofit designated by the merchant 3A or the preferred nonprofit of the consumer 5A. Participants can view the overall social impact of the merchant 4 prior to the purchase by viewing the social impact meter 10A on the merchant website 20.

FIG. 19.1 is a visual example of an exemplary checkout button process to verify Participants 19 and consumer purchase data 22, 24. Participants are able to login and/or register 21, view the designated nonprofit 23, and view consumer purchase 22, 24 from the website of the merchant 3.

FIG. 19.2 is a visual example of an exemplary checkout button process to find and choose a preferred nonprofit 5A to benefit at the point-of-sale. Consumers 5 choose from a pre-selected list of nonprofits 4 connected to the portal 1. At any time through the process, the consumer 5 can review and purchase 24 the product and/or service.

FIG. 19.3 is a visual example of an exemplary checkout button process to confirm and change the designated nonprofit 4 of participants 19. At the point of sale, a merchant 4 has already designated a nonprofit 4 to benefit. The consumer 5, if given the option by the merchant 4, can change the designated nonprofit of the merchant 3A to the preferred nonprofit of the consumer 5A. At any time through the process, the consumer 5 can review and purchase 24 the product and/or service.

FIG. 19.4 is a visual example of an exemplary Checkout Button Process to review and pay 24 to generate revenue for the designated nonprofit 11. The social impact revenue generated is ultimately divided amongst the participants 1, 11, 12. The consumer 5 clicks on the checkout button 9A to complete the order and benefit the nonprofit 4.

FIG. 19.5 is a visual example of an exemplary Checkout Button Process to measure, verify, and market the designated revenue for a nonprofit 11 through a certificate 26 for the Participant 19, specifically the consumer 5. The consumer 5 receives the certificate 26 as a visual reward for their participation with the merchant 3 through a revenue generating tool 9 connected to the portal 1. Consumers 5 may view their receipt 25, return to the merchant website 20, return to the portal 1, and/or view the consumer account 5.

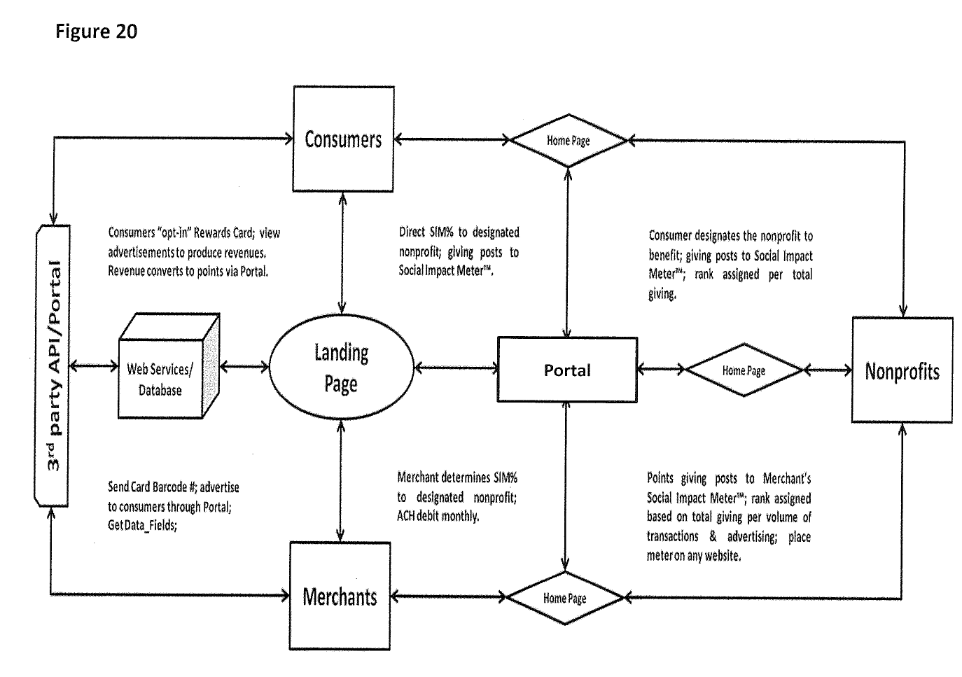

The exemplary flowchart of FIG. 20 illustrates how the Portal 1 interacts between consumers 3 and merchants 5 to produce initial revenues for passive giving. In this exemplary illustrated embodiment, a consumer 3 opts-into the program by, for example, designating “rewards points” from a credit card, or allowing the review of advertisements while browsing on the Internet to generate points. The consumer then designates the nonprofits(s) to receive the benefit of the programs that the consumer has opted into. Thereafter return, as the consumer 3 makes purchases from the merchant 5, or spends time on the Internet with advertising displays posted from the merchant 5, revenue points are passively generated by these consumer activities. These points are posted on the social impact meters of both the consumer and the merchant The merchant 5 designates a percentage of revenues to be sent to the nonprofit, and on a periodic basis (e.g. monthly), those revenues are sent to the nonprofit.

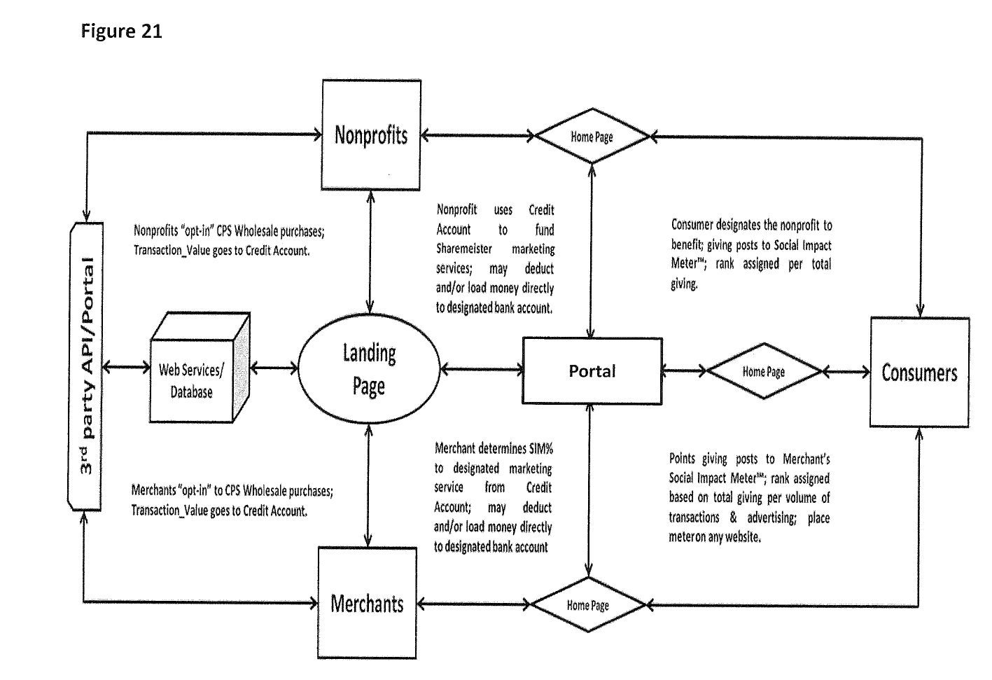

The exemplary flowchart of FIG. 21 illustrates how the Portal 1 interacts between nonprofits 4 and merchants 5 to produce initial revenues for passive giving. In this exemplary illustrated embodiment, a nonprofit 4 opts-into the Portal by, for example, agreeing to pay a certain amount to the Portal in exchange for participation in revenue generating events and programs sponsored through the Portal. Then, according to the example illustrated in FIG. 20 above, passive activity by a consumer 3 which has designated the particular nonprofit 4 generates revenue for that nonprofit 4. The nonprofit 4 is provided with points posted to a social impact meter, and periodic distributions of generated revenues.

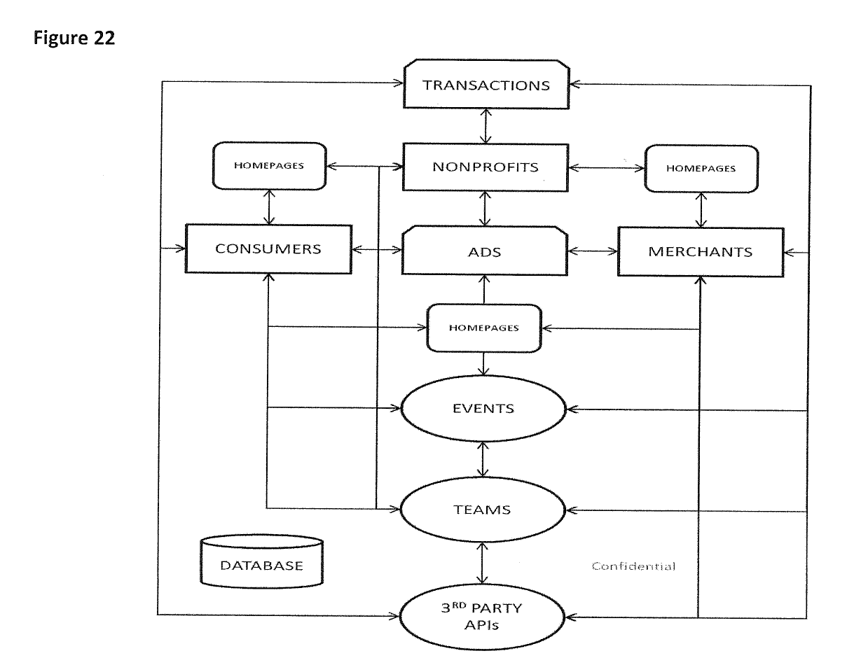

FIG. 22 is an overall block diagram of an exemplary embodiment of the Portal showing the how information is provided to, from and between consumers, nonprofits and merchants in order to generate revenues (through such things as advertising, events, teams, and third party APIs), report back the results of the revenue generating activities (through social impact meters on the web sites of consumers, merchants and nonprofits), and distribute those revenues at appropriate times.

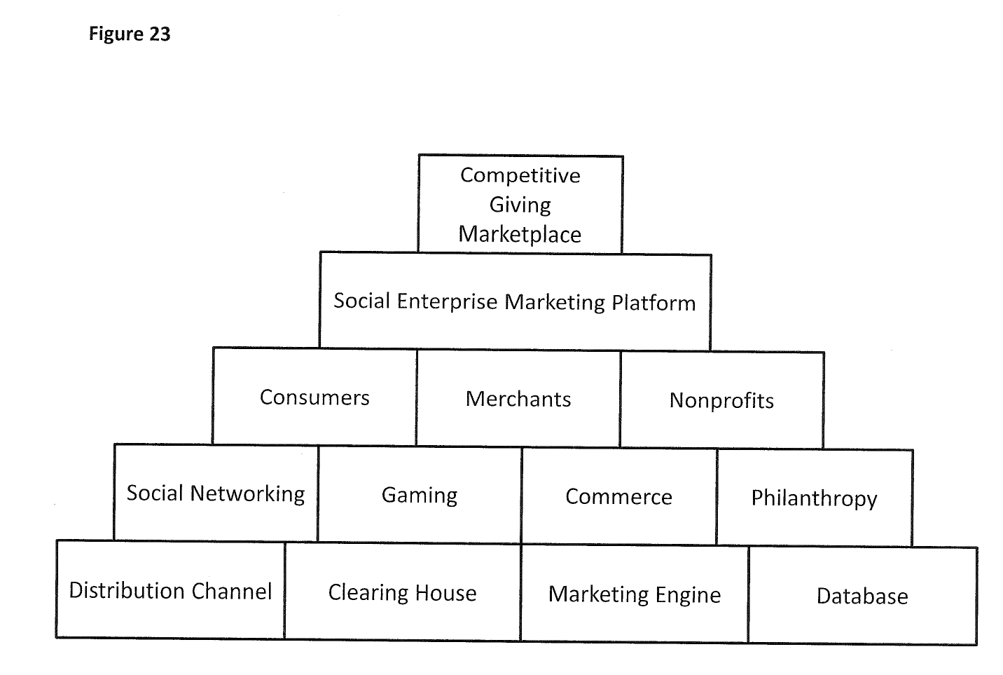

FIG. 23 illustrates how a CGM is supported by a social impact marketing platform (Portal 1) of the present invention, which connects consumers, merchants and nonprofits together. The portal achieves the multiple goals of philanthropy, commerce, gaming and social networking, and uses tools including distribution channels, clearing houses, marketing engines and databases to achieve these goals.

It is to be appreciated that those seeking funding through embodiments of the Portal 1 will ordinarily pay a fee for the opportunity, which may be any appropriate negotiated amount or percentage. Because they receive exposure and marketing opportunities, merchants 3 and merchant processors 2 may also pay negotiated fees for their participation with the Portal. However, since increased participation by consumers 5, merchants 3 and merchant processors 2 at the Portal 1 ordinarily leads to additional opportunities for generating funding, referral fees may be provided to merchants for referring their customers to the portal, and to merchant processors for referring their merchants to the portal.

In some aspects, embodiments of the present invention provide systems for at least one participant to interact with at least one connected and/or integrated revenue generating tool to produce revenue for at least one nonprofit and market the result with at least one marketing tool against at least one other participant interacting with at least one connected and/or integrated revenue generating tool to produce revenue for at least one nonprofit and market the result with at least one marketing tool; these systems and methods may be further provided through a portal, website, application, device, or any other transactional medium.

In other aspects, embodiments of the present invention provide systems that integrate with any revenue generating event connected to a portal for the purposes of benefiting a nonprofit to promote and market the participant through a social impact meter, integrity meter, competitive giving event, or other game featuring the interaction of consumers, merchants, and nonprofits; these systems and methods may be further provided through a portal, website, application, device, or any other medium that connects to a portal; the systems may further comprises in-store transactions through a terminal, online transactions through a portal, and/or any other medium of transaction.

In other aspects, embodiments of the present invention provide systems the integrate at least one transactional medium with another transactional medium correlated to the same user; further comprising that any point created is combined with other points inside a single user account; further comprising each user interaction creating a point that can be given to a nonprofit; further comprising credits that can be accounted through at least one marketing tool for all users involved in the transaction, giving, or marketing of the point; these systems and methods may be further provided through a portal, website application device, or any other transactional medium for purposes of benefiting a nonprofit.

In other aspects, embodiments of the present invention provide methods for at least one consumer, nonprofit, and/or merchant to create a team and compete with at least one other team in a timed competition event to benefit nonprofits through revenue generating tools connected to a portal; further comprising methods for said participants to create a team to benefit a nonprofit and compete with at least one other team in a timed competition event to benefit nonprofits through revenue generating tools connected to a portal; further comprising of a CGM featuring the merchants that market their altruistic side for purposes of joining a team to generate sales; further comprising of a network of participants rated and combined together to produce competitive regions and rankings; these systems and methods may be further provided through a portal, website, application, device, or any other medium.

In other aspects, embodiments of the present invention provide methods for at least one participant to link a transactional device to a portal that integrates with the online and/or in-store terminal of a merchant for purposes of generating revenue for a nonprofit from the completed transaction, and marketing the result through said marketing tools connected to the portal; further comprising of the same function for online transactions through a portal, or revenue generating tool, that integrates with the shopping cart of a merchant for purposes of generating revenue for a nonprofit from the completed transaction and marketing the result through said marketing tools connected to the portal.

In other aspects, embodiments of the present invention provide methods for online advertising that generate points based upon the advertising duration and value of the advertising divided by the time spent online by the consumer; these systems and methods may be further provided through a portal, website, application, device, or any other medium; further comprising the methods occurring above the fold of a page with no scrolling; further comprising the methods creating points based upon the consumer interaction with any type of advertising or marketing medium.

In other aspects, embodiments of the present invention provide methods to integrate the value of a point from time spent online by the consumer with the value of designated nonprofit revenue from consumer purchases of revenue generating tools connected to the portal to create a shared-value point; further comprising a social gateway for processing transactions connected to a portal that redirects a portion of revenue to a nonprofit as designated by the participant; further comprising of a clearinghouse that converts the value of points generated from a browser application, or other points integrated to a portal, with the value of the designated nonprofit revenue from consumer purchases connected to a portal into a shared-value generated points directed towards nonprofits; further comprising the shared-value generated points being directed towards goods and services.

In other aspects, embodiments of the present invention provide methods for a participant to change the designated nonprofit at the point-of-transaction; these systems and methods may be further provided through a portal, website, application, device, or any other medium.

In other aspects, embodiments of the present invention provide methods for points to be grouped through teams selected by users for purposes of benefiting a nonprofit or other entity the team has elected to represent.

In other aspects, embodiments of the present invention provide methods for consumers, nonprofits, & merchants to engage inside a platform that consolidates all point platforms into a single location to market the giving of all participants; where a point is assigned to a user for an interaction with any transaction and/or advertising portal for purposes of giving to a nonprofit and/or the purchasing of product/service with value the point(s).

In other aspects, embodiments of the present invention provide methods for consumers to create their own game that quantifies their purchases and/or viewed advertisements from a merchant through any type of portal to earn points for a nonprofit; further comprising points that can be credited back to the consumer for personal rewards redeemed through an online portal, website, application, device, or any other medium; further comprising a method for merchants to advertise to users that are reaching a goal based on the game played.

It is to be understood that variations, permutations, and modifications of the systems, methods and apparatuses of the present invention may be made without departing from the scope thereof. One or more features of an exemplary embodiment as described above may be practiced in conjunction with other exemplary embodiments as described above.

It is also to be understood that the systems, methods and apparatuses of the present invention are not to be limited by the specific embodiments or examples disclosed herein, but only in accordance with the appended claims when read in light of the foregoing specification.

### KEY

1. Portal
2. Merchant Processor
3. Merchant
   a. Merchant Choice
4. Nonprofit
5. Consumer
   a. Consumer Choice
   b. Team Leader
6. Financial Institution
7. Competitive Giving Marketplace (CGM)
   a. Competition Event
   b. Time Limit of Competition Event
8. Administrative System
9. Revenue Generating Tools
   a. Checkout Button
   b. In-Store Purchase
   c. Browser Application
   d. Generating a Point
   e. Other Revenue Sources
10. Marketing Tools
   a. Social Impact Meter
   b. Integrity Meter
11. Designated Revenue for Nonprofits
12. Revenue (referring to marketing revenue for Merchant Processors and Financial Institutions)
13. Direct Consumers to Portal
14. Direct Merchants to Portal
15. Team A/Team B
16. Cloud Network
17. 3rd Party APIs
18. Data Storage Device
19. Participants
20. Merchant Website or other form of website
21. Verify Consumer
22. Consumer Purchase/Transactional Data
23. Confirm and/or Change Designated Nonprofit
24. Review & Pay
25. Confirm Purchase & Receipt
26. Certificate
27. In-store Terminal of Merchant and/or other seller
28. Advertise
29. Ad Display—served on the left side above the fold of the web page.
30. News Feed—clickable headlines from nonprofits that consumers have selected.
31. Point Counter—point tracker with short cut to donate
32. Social Media Links
33. Gateway and/or Clearinghouse
34. Overall: Ranking of Social Impact
35. Top Genre: Ranking of Social Impact
36. Participant Home Page (s)
37. Online Active Time
38. Value of Point
39. Value of Revenue
40. Shared-Value Generated Point

### Systems and Methods for Distributing Electronic Media

The following disclosure relates generally to the distribution of electronic media. More specifically, the following disclosure relates to systems and methods for distributing electronic media at no out-of-pocket expense to end users in conjunction with the display of advertising during the distribution of such electronic media.

Background

With the increased availability of the Internet, electronic media content, such as music, movies, television shows, and books, has increasingly been placed online In many cases, that media content can be pirated, stolen and distributed over the Internet in a way that musicians, producers, authors, and the industries which represent them, cannot, at present, monetize.

The first wave of piracy through transferring media content electronically online mainly affected the music industry. This was due primarily to the advent of compression and decompression algorithms (also known as “codecs”) that enabled traditionally large size music files (commonly referred to as “wave” or “.wav” files) to be compressed into relatively small files, such as MPEG-1 audio layer 3 (“.mp3”) files. These codecs reduce the amount of data required to represent an audio recording while enabling a computer processor to play back the file without much if any perceived loss in audio quality. While the transfer of a way file from one computer to another over a network connection could take hours, the availability of .mp3s enabled the exchange of music in a manner of minutes (or less) over the Internet. As technology and the speed of the Internet has improved over the years, it has become increasingly easier to transfer larger forms of electronic media content such as full length movies, videos and even streaming television programs.

The general ability by a large majority of consumers to transfer electronic media content over the Internet has created serious revenue problems for original content developers in the music, movie, television, and similar industries. To this day, none of these industries have been able to harness the large quantity of electronic media content transfers through the Internet. Instead, each respective industry has endeavored to control or even stop the exchange of electronic media content through the Internet. For example, Google was served with a one billion dollar copyright lawsuit from VIACOM after purchasing YouTube, which enables users to post videos that anyone can stream. The lawsuit alleges that YouTube infringes various copyright lawsuits by allowing its users to post, share and play copyright protected material through its web site. In a similar instance, the music industry, through the Recording Industry Association of America (“RIAA”), has sued college students and home users all across the United States for allegedly illegally downloading and sharing online music media files. In both cases, VIACOM and the RIAA are attempting to collect royalties for each exchange of the electronic media content.

The resulting question for the advertising, entertainment, music, and similar industries (collectively the “media industry”) is how to monetize the transfer of electronic media content over networks, such as, for example, the Internet. In one aspect, the answer seems very basic: sell electronic media content to the public through online resources such as the Internet. Unfortunately, the original model for acquiring online media content was through peer-to-peer (P2P) networks, such as Napster in the late 1990's, which enabled consumers to obtain and share electronic media content for free. Now, purchasing electronic media content online seems counterintuitive to most people given that for many years consumers have largely been able to obtain electronic media content for free. Despite the many lawsuits brought against Napster, other P2P networks, and individuals by the media industry and copyright owners, consumers can still readily obtain electronic media content for free through the Internet. Those consumers who do pay for music cannot ignore the overwhelming fact that the electronic media content is so readily available for free throughout the Internet that, in essence, it “doesn't feel like stealing.” Thus, the media industry as a whole is faced with an environment in which consumers do not want to pay for electronic media, and technology which enables consumers to do just that.

Because consumers are now more than ever able to watch and distribute electronic media content in a way that does not result in payment back to the media content owner, the media industry is experiencing a continuous downward spiral of revenue. At present, this is particularly visible in the music industry. Moreover, as consumers continue to increasingly receive entertainment-related content through electronic and/or networked distribution (e.g., the Internet), the demand for physical multimedia, such as CDs, DVDs and books sold in retail stores continues to diminish. This, in turn, results in a decreasing amount of media content being created and provided to the public: The Hollywood writers' strike, decreasing quantities of new artists introduced into the marketplace, a significant and continuing drop in television viewing, thousands of worker layoffs at a variety of entertainment companies, and entertainment companies closing stores and/or going out of business can all be attributed, at least in part, to the diminished revenue returns the media industry receives from the old system of distributing multimedia content. As more people gain accessibility to the Internet, the profitability of selling and distributing media content through traditional brick and mortar retail stores may become decreasingly feasible with time.

Despite the foregoing, the advertising industry continues to grow and succeed online Online advertising continues to move toward a system that places less risk on the advertiser and more risk on the publisher (i.e. the content owner) of the web site. The first online advertising model comprised advertisements that streamed across a page. Advertisers paid the web site owner as a function of the number of views of a webpage displaying the advertisement, known as the cost-per-thousand or “CPM” model. Eventually, advertisers realized that the Internet had an added function that traditional advertising (e.g. radio, television, billboards, etc.) did not: a consumer could “click” the advertisement and visit the corresponding web site of the advertiser. As a result, advertisers only wanted to pay for those users who clicked on the particular advertisement, creating a cost-per-click or “CPC” advertising model. The CPC model gives advertisers a more quantifiable method for determining the value of the advertisement. While advertisers tend to prefer this model, web site owners have been reluctant to move to the CPC model because it shifts the risk away from the advertiser and on to the web site owner. Web site owners must shoulder the risk for an advertiser who advertises a bad or unpopular product.

Web site owners began comparing the performance-based CPC model to the initial CPM model. The comparison endeavored to generate comparable revenue for the web site owner based on either the CPC model or the CPM model. Typically, the result of one thousand advertisement views by a consumer translated to one dollar to two dollars of revenue to the web site owner. This information enabled advertisers to determine which web sites best suit a particular form of advertising model. Web sites that have a high volume of traffic could continue operating under the CPM model, while the performance-based CPC model was the only way lower traffic websites could obtain advertising revenue from advertisers.

The advertisement industry also soon realized that not all advertisement placements were equal. Rather, the location of an advertisement on a web page could be crucial and even determinative of whether a user actually clicked on the advertisement. Advertisements placed at the top of a scrollable web page (e.g., a search engine results page) would receive more clicks than the corresponding advertisement placed at the bottom of the web page. While the owner of the advertisement placed at the bottom of the web page has a viable complaint based on the placement of the advertisement relative to an advertisement placed at the top of the web page, this system of placing advertisements was simply a result of the accepted scrolling design and format of a typical web page.

In another aspect of online advertising, advertisers became increasingly reluctant to pay for just “clicks” under the CPC model. Advertisers began conditioning payment on clicks that convert into actual sales. In view thereof, consumers are required to engage with the advertiser beyond simply clicking on the advertisement and going to the advertiser web page. New advertising models such as cost-per-action (“CPA”) and cost-per-lead (“CPL”) developed in view of these new principles. In the CPA model, advertisers place advertisements on a web page and are only required to pay the web site owner if a consumer purchases goods and/or services from the advertiser. Advertisers accordingly pay the web site owner a percentage of the sales generated through the advertisement. Tracking technology was deployed to monitor the consumer after the consumer clicked on a particular advertisement and any goods or services purchased through the advertiser. Accordingly, the owner of the web site on which the advertisement was placed would receive a portion of the revenue created from the sale. In the CPL model, web site owners host a portal in which advertisers compete with one another to advertise on the web site and ultimately obtain the business of the consumer. In other words, the web site owner is used to create business leads for the advertiser. The advertiser then reimburses the web site owner upon events such as the completion of a sale, start of a service, or joining of a sweepstakes. In this model, the web site owner is a middleman or a sales representative for the advertiser. Both the CPA and CPL models essentially take all the risk out of advertising for the advertiser.

Harnessing advertising with respect to electronic media content has been especially difficult online as the Internet is always, and very rapidly, changing. The media industry has struggled for years to rectify the rapid and constantly increasing piracy rate for electronic media content. At best, members of the entertainment industry have offered several poor solutions to this problem. For example, musicians and bands have resorted to giving music away for free in hopes of later obtaining revenue by selling tickets to live concerts and selling merchandise. Other musicians post music online and request that fans download the music and pay “whatever you like.” Large music entities, such as the RIAA, have sued the public for downloading and distributing electronic media content without authorization. Each of these methods search for an answer to distribution problems, but none of these concepts provide the desired solution: compensation to the media content owner for the development and distribution of the electronic media content within a framework that consumers will accept and use.

Thus, there is a need for a system that can simultaneously monetize the transfer of media content, make it freely available to the consumer in order to harness the culture mindset, and advantageously use current technology to drive sales of the electronic media content. Media producers and developers should receive adequate compensation for their innovations, and should be encouraged to produce more novel works. The present disclosure fulfills these needs and provides further related advantages.

### Summary of Systems and Methods for Distributing Electronic Media

The present disclosure provides systems and methods for the distribution of electronic media content to consumers. Those who wish to obtain media content at no out of pocket expense, but legally and with valid copyright licenses, may engage with one or more advertisements while viewing the media content. The advertisements and the media content may be placed such that the user cannot view the media content without simultaneously viewing the advertisements. An administrative system coordinates the relationships between media content providers, advertisers, and users, and the receipt and provision of content throughout the system. Advertising revenue generated through this system may be distributed back to the administrator, the media content providers, users, and other individuals, as desired.

Rather than relying on old advertising revenue models, such as the CPM, CPC, CPA, and CPL models, the present disclosure provides a new advertising model—cost-per-time. Users are actively exposed to advertising content because those users want to obtain the media content simultaneously displayed. As the number of users increases, advertisers are also incentivized to place more advertising at higher rates, generating more advertising dollars that users may receive as value for engagement with or exposure to the advertisements. This media distribution model further incentivizes media content providers to provide media content for distribution because the providers can receive payment in exchange for their works Finally, users' incentives to illegally download or pirate electronic media content are eliminated under this model, because they can receive media content without incurring any out-of-pocket expenses for the media content.

### Detailed Description of Systems and Methods for Distributing Electronic Media

The present disclosure provides systems and methods for the distribution of electronic media content that is free to the consumer. FIG. 24

Several aspects of the embodiments described herein will be illustrated as software programs or components stored in a computing device. As used herein, a software program or component may include any type of computer instruction or computer executable code located within a memory device and/or transmitted as electronic signals over a system bus or network. A software program may, for instance, comprise one or more physical or logical blocks of computer instructions, which may be organized as a routine, program, object, component, data structure, etc., that performs one or more tasks or implements particular abstract data types.

In certain embodiments, a particular software program may comprise disparate instructions stored in different locations of a memory device, which together implement the described functionality of the program. Indeed, a program may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software programs may be located in local and/or remote memory storage devices.

In accordance with the embodiments described in greater detail below, and as shown schematically in FIG. 24, the systems and methods disclosed herein create a media distribution system 10 through which one or more users 100 may acquire electronic media content 135 in exchange for engaging with or being exposed to one or more advertisements 127 delivered by an advertiser 120 through an administrative system 110. Advertising fees 125 obtained from one or more advertisers 120 may be divided according to a predetermined formula among the owner and/or administrator of the administrative system 110, media content providers 130, users 100, other individuals or entities, or any combination thereof. The media distribution system 10 incentivizes one or more media content providers 130 to provide media content 135 for distribution through the administrative system 110 because the providers 130 receive payment in exchange for their works 135, and eliminates users' 100 incentive to illegally download or pirate electronic media content 135 because they can acquire electronic media content 135 for free. As the number of users 100 increases, advertisers 120 are also incentivized to place more advertising 127 through the distribution system 10 at higher rates, generating more advertising dollars 125 that may be divided among various constituencies of the system 10.

A media content provider 130 may be any person who generates, owns, licenses, or otherwise possesses media content 135. For example, media content providers may be, but are not limited to, musicians, artists, producers, music labels, television studios, authors, and/or any other person or entity that has the authority to distribute, sell and/or license the media content. Media content 135 may include, but is not limited to, music, movies, news, original programming, advertisements, independent and/or original works, television shows, music videos, video games, web log (aka blog) postings, and electronic books (also referred to as e-books). As appropriate, the media content provider 135 can be required to state, confirm and/or provide proof that he/she has the authority or represents the party that has the authority to allow distribution of the media content through the system 10.

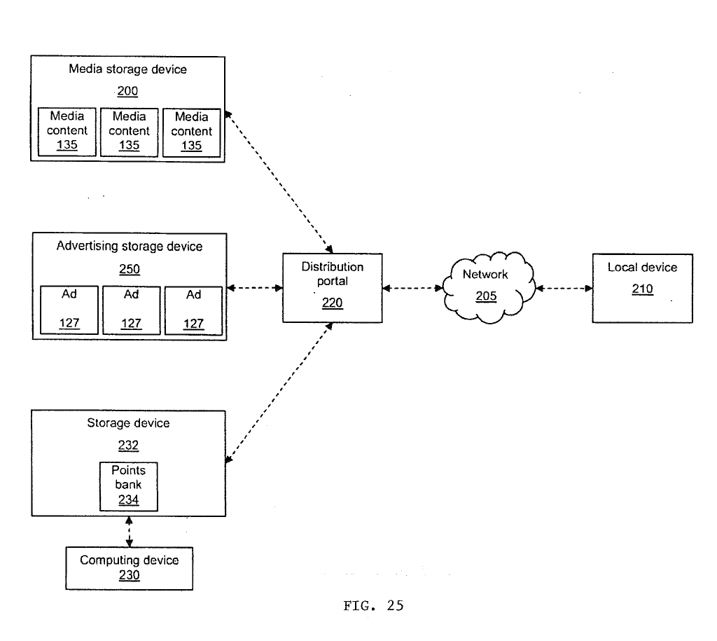

FIG. 25 is a block diagram of an exemplary embodiment of the system 10. As shown, the system may comprise at least one media storage device 200 for the receipt and storage of media content 135. Such a media storage device 200 may be one or more computers, servers, databases, or other devices capable of (either individually or collectively) storing electronic media content and communicating with other electronic devices. As necessitated by storage capacity and other practical considerations, media content 135 may be stored in multiple media storage devices 200.

The embodiment may also comprise at least one advertising storage device 250 for the receipt and storage of at least one advertisement 127, which may be a graphic or an image, a moving picture, video, or audio, as desired by the advertiser. The advertising storage device 250 may be one or more computers, servers, databases, or other devices capable of (either individually or collectively) storing electronic advertising content and communicating with other electronic devices. As necessitated by storage capacity and other practical considerations, advertisements 127 may be stored in multiple advertising storage devices 250.

A user 100 (not shown) interacts with the system through a distribution portal 220 using an electronic device 210. The distribution portal 220 may be, but is not limited to, a web site or web portal which may be accessed by the user 100 through a web browser program or the like running on the device 210. The electronic device 210 may be, but is not limited to, a personal computer (either desktop or laptop), a personal digital assistant, a cellular telephone, a multimedia content player (such as an iPod or Zune device), a television (with or without a set-top-box), a digital video recorder, a networked video player, or some other similar type of device. The device 210 may communicate with the distribution portal 220 through any appropriate network or direct connection including, but not limited to, the Internet, a local area network, a wide area network, a cellular network, a satellite link, a direct connection, and/or any combination thereof. Through the distribution portal 220 the device 210 may gain access to (either directly or indirectly) the stored media content 135 on the media storage device 200 and/or the advertising 127 on the advertising storage device 250. Accordingly, a user 100 may use the device 210 to access media content 135 stored on the media storage device 200, to view and/or listen to that media content 135 on a device 210, to download or copy media content to the device 210 or another device, and/or to view or listen to advertisements 127 on advertisement storage device 250.

The embodiment of FIG. 25 may further comprise one or more computing devices 230 (such as a computer, server or the like) and/or storage devices 232 (such as a database, hard drive, file server or the like) as necessary for implementing the functionality of the system. As one example, the computing device 230 and storage device 232 perform the tasks necessary to allow a user to engage with the system (e.g., register and/or log-in); to operate the distribution portal (e.g., to act as a web server to send the distribution portal's web pages to the user's device and receive information back from the user and/or the user's device); to keep track of the amount of time that a user 100 has engaged with the distribution portal and/or advertisements 127; to record and compute information about the media content 135 that a user has viewed, listened to, downloaded or otherwise interacted with; to credit and/or debit points from the user's points bank 234; and/or other tasks that may be appropriate or necessary for the operation of the system 10.

It is to be understood that the various components described herein and the functions attributed to them may be divided among one or many devices. For example, the system may use more than one media content device 200 or advertising storage device 250, or a single device may act as both a media storage device 200 and advertising storage device 250. As another example, the functionality of the distribution portal 220 may be divided between one or more physical devices. As yet another example, the functionality of the computing device 230 and storage device 232 may be performed by the same device. It is to be understood that the examples recited here are not intended to, and do not, limit the manner in which the functionalities of the system may be divided among the one or more hardware devices and/or software modules comprising the system. It is further to be understood that the system as described herein does not in any way limit the manner in which one of the hardware or software components of the system may communicate or otherwise exchange information or data with another component of the system.

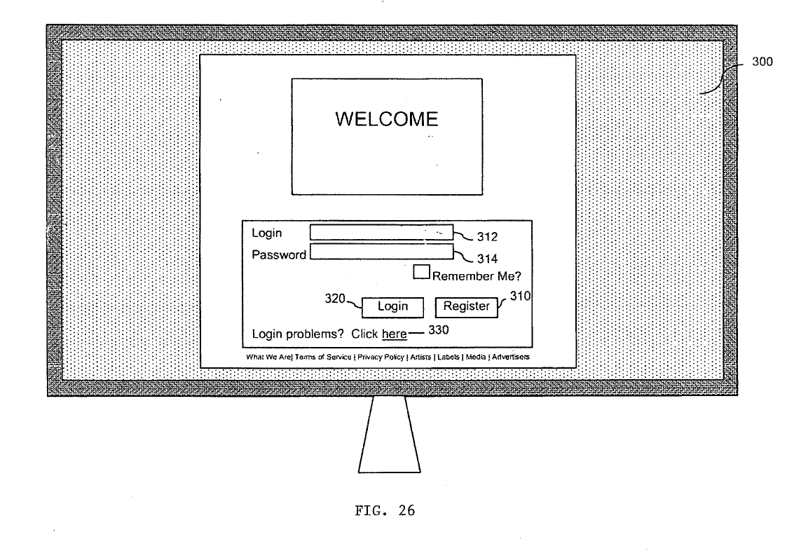

Prior to accessing the distribution portal 220, the user 100 may be required to register with the distribution portal 220. The user 100 may be required to submit information such as his or her e-mail address, a password, general demographic information such as age and gender, geographic location, any other relevant or useful information, or any combination thereof. Following registration, the user 100 may be required to log into the distribution portal 220 using his or her registered credentials each time the user 100 wishes to access media content 135. A block diagram of an exemplary screen 300 for registering with or logging-in to the distribution portal 220 is shown in FIG. 26. A user 100 may select the register option 310 to register with the system, at which point the user will be directed to one or more screens (not shown) to provide his or her registration information. Methods and systems for allowing a user to register with a distribution portal are well-known and will not be discussed in detail here. Alternatively, if already registered, a user 100 may enter login name 312 and password information 314 and select the login option 320 for logging into the distribution portal 220. The exemplary screen may also include one or more options for addressing login problems 330 and one or more options to select, information related to terms of service, privacy policy, artists, labels, media, advertisers, information about the distribution portal, and/or any other information that may be appropriate or desired. It is to be understood that the login screen 300, and the manner in which a user 100 is permitted to register or log into the system, or the type of information that may be displayed or accessible from the screen 300 is not limited in any way.

In one embodiment of the disclosure, other constituencies of the system 10 may also be required to register and log-in when they wish to interact with the system 10. For example, an advertiser 120 may register and log in before submitting advertisements for distribution to users through the distribution portal 220, and/or a media content provider 130 may register and log in before submitting media content to be distributed to users 100 through the distribution portal 220.

When a user 100 logs into the distribution portal 220, the distribution portal 220 may display a wide variety of information on the user's device 210. As one example, the distribution portal 220 may display selected media content 135 on the device 210. As another example, the distribution portal 220 may display information relating to the popularity of specific media content, such as “top 10” lists or the like on the device 210. The distribution portal 220 may also display community information, such as media content 135 relevant to the user's geographic region or content preferences. As yet another example, the distribution portal 220 may display a user's profile or credential information, or public information about other users on the device 210. If the user 100 has previously accessed the distribution portal 220 to access media content 135, the distribution portal 220 may display information about that content 135, such as playlists of all or a portion of the previously-accessed content 135. It is to be understood that this information is not mutually exclusive, and there is no limit in the content of the information that may be displayed by the distribution portal 220, or the manner and/or format in which the information is displayed or presented on the device 210.

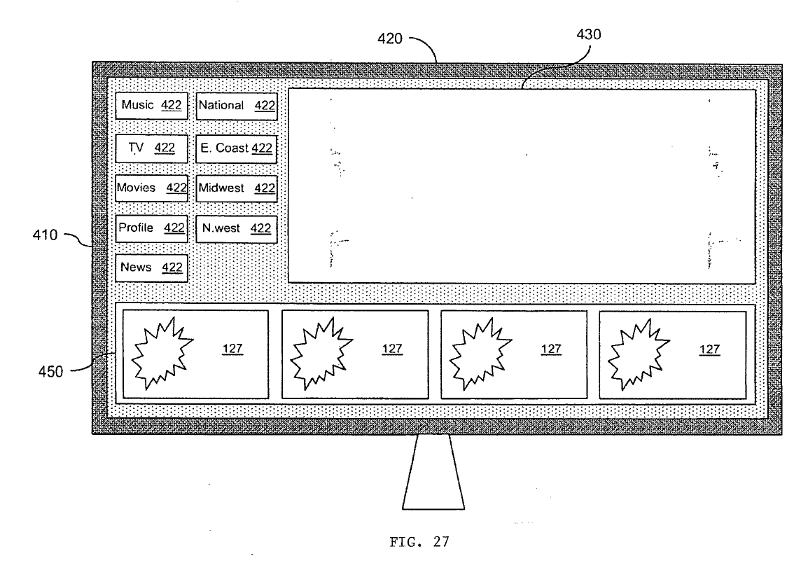

FIG. 27 is a block diagram of an exemplary representation of the information and/or content that may be displayed on a device 210 after a user has logged into the distribution portal 220. In this exemplary embodiment, the device 210 is a personal computer (not shown in its entirety) with a display 410 running a web browser program (such as Internet Explorer, Safari or Firefox) for displaying one or more web pages 420 used to access and communicate with the distribution portal 220. It is to be understood that the disclosure is not limited to use of a web browser and any appropriate interface and/or protocol may be used to communicate with, and display information received from, the distribution portal 220.

In the exemplary embodiment of FIG. 27, the web page 420 is non-scrollable, such that the entirety of the content provided by the distribution portal 220 to be displayed on the screen 410 is viewable on the screen 410 without the user 100 having to scroll down or up in order to view the content and/or information. By way of example and not limitation, the web page 420 may comprise one or more links or buttons 422 for gaining access to various communities comprising the distribution portal 220, a content display section 430 for displaying or playing information and/or media content 135 as appropriate and based on selections made by the user 100, and a section 450 for displaying one or more advertisements 127.

As one example, the web page 420 may include a link that allows the user 100 to gain access to a section of the distribution portal 220 for browsing and/or listening to music, a link that allows the user 100 to gain access to a section of the distribution portal 220 for browsing and/or viewing TV shows, a link that allows the user 100 to gain access to a section of the distribution portal 220 for browsing and/or viewing movies, a link that allows the user 100 to gain access to a section of the distribution portal 220 for browsing, viewing and/or editing the user's own profile information, or to browse the profiles of other users, a link that allows the user 100 to gain access to a section of the distribution portal 220 for browsing and/or viewing news, and one or more links to allow the user 100 to gain access to one or more sections of the distribution portal 220 that display content and/or information that pertains to specific geographic regions (e.g., the most popular media content in that specific geographic region). It is to be understood that the links discussed herein are exemplary and are not intended to limit the type or number of links that may be displayed on the device 210 or accessed by the user 100, and/or to limit the type or number of communities or sections that comprise the distribution portal 220.

As the user 100 selects one or more links 422, the appropriate information that is retrieved by the link is displayed on a section 430 of the web page 420 that changes based on the information requested by the user 100. For example, if the user 100 selects the movies link 422, the section 430 of the web page 420 may display information related to movies, such as movies that may be available for viewing and/or download, top 10 or similar types of list, or the like. If a user 100 elects to view a particular movie, then the section 430 of the web page 420 displays an appropriate movie player to display the movie. If instead, a user 100 selects the music link 422 and elects to listen to a particular song, then the section 430 of the web page 420 may display an appropriate music player to play the song.

One or more advertisements 127 may be displayed in section 450 of the web page for displaying advertisements. Because of the non-scrollable nature of the web page 420, the one or more advertisements 127 displayed in the advertisement section 450 will be viewable the entire time that a user 100 interacts with the distribution portal 220 through the links 422 and content display section 430. For example, while the user 100 views or listens to a first media content 135, the user will also be able to view advertisements 127. If the user 100 decides to view or listen to a second media content 135, the information in the content display section 430 will change (e.g., a the movie player will play a different movie in the content display section 430) but the advertisements 127 displayed in the advertisement section 450 will still be viewable. Thus, as a user 100 navigates through the various sections of the distribution portal 220, the content and/or information displayed in the display section 430 and/or the links 422 may change, but the advertising section 450 remains visible to the user 100 and advertisements 127 may continue to be displayed to the user 100 while the user 100 interacts with the distribution portal 220. Accordingly, the advertisements 127 need not be embedded into or placed in between the media content 135 (e.g., playing an advertisement in between segments of the media content) or placed over the electronic media content 135 (also referred to as overlaying an advertisement on the media content), as is the current practice in some online web sites and on network television.

In the example of FIG. 27, a user 100 may view one or more advertisements 127 concurrently with viewing the media content 135 or while otherwise interacting with the distribution portal 220. In one embodiment, one or more advertisements 127 displayed in the advertising section 450 may change at specific time intervals while the user 100 views or listens to the media content 135 or otherwise interacts with the distribution portal 220. By way of example and not limitation, if the user 100 selects a three-and-a-half minute music video, the advertisement(s) 127 may change every thirty seconds (or seven times), while the user 100 views the music video. If four advertisements 127 were simultaneously placed in the advertising window 450, and those advertisements 127 were changed every thirty seconds, the user 100 would view twenty-eight different advertisements 127 while viewing the music video. Of course, it is to be understood that if multiple advertisements 127 appear at the same time, each advertisement 127 may change or be replaced on a different schedule. In other words, advertisements 127 need not be replaced simultaneously.

In one embodiment of the disclosure, the distribution portal 220 may be organized such that parts of the portal are scrollable and others are not. Referring to the exemplary block diagram of FIG. 27, the web page 420 may be organized such that the display section 430 and the section displaying the links 422 may be scrollable, but the advertisement display section 450 is non-scrollable. In such an embodiment, even though a user may scroll through the content displayed in section 430, the advertisements 127 displayed in the advertisement display section 450 remain viewable to the user and the user may not navigate away from the advertisements while engaging with the distribution portal 220.

It is to be understood that the interface through which the user interacts with the distribution portal 220 need not occupy the entire physical screen 410 of the device 210. For example, in the exemplary embodiment of FIG. 27 in which the user interacts with the distribution portal 220 through a web browser running on the local device 210, the browser window on which the web pages 420 are displayed need not occupy every pixel of the display 410. In other words, the generally non-scrollable web page 420 (and/or the window in which it appears) may be of any appropriate size and need not (but may) occupy every pixel on the display 410.

In one embodiment of the disclosure it may be preferable to charge the advertiser 120 an advertising fee 125 for the display of an advertisement 127 within the distribution portal 220. This advertising fee 125 may be calculated as a function of the amount of time that the advertisement is displayed on the device 210 through the distribution portal 220. This system and method of charging a fee for advertisements may also be referred to as a “cost-per-time” (“CPT”) model. Because of the substantially non-scrollable nature of the distribution portal 220 as displayed on the device 210, advertisements 127 can be displayed while a user 100 spends time engaging with the distribution portal 220, whether viewing or listening to media content 135, browsing top 10 lists or the like, updating profile information, viewing other users' profile information, viewing information other than media content, or any other type of interaction or engagement with the distribution portal 220.

Time spent within the distribution portal 220 may be calculated as a background process; in other words, the distribution portal 220 records time for the user 100 so long as he or she is accessing media content 135 or otherwise engaging with the distribution portal 220. Alternatively, the distribution portal 220 may be configured to require the participation of the user 100, such as, for example, by clicking on a button at regular intervals to signal to the distribution portal 220 that the user 100 is still engaged. It is to be understood that other techniques for ensuring that the user 100 remains engaged with the distribution portal 220 may be available and the present disclosure does not in any way limit the methods or techniques that may be used to determine whether and the amount of time that a user 100 remains engaged with the distribution portal 220.

Advertising rates may be set during a “sweeps” period, much like they are set with respect to television advertising rates. In a sweeps period, an advertiser 120, the administrative system 110, or another appropriate party may survey a group of one or more users 100 to assess user-related statistics, such as, for example, the average time each user 100 spends engaged with the distribution portal 220, user demographics, peak usage periods (including time of day and time of the year), and/or any other information helpful in setting advertising rates. Advertising rates may also be set based on the nature of any media content 135 viewed. In one embodiment of the disclosure, advertising rates may be fixed so that in the average time it takes to view or listen to the media content 135 a sufficient number of advertisements 127 can be displayed to generate sufficient advertising revenue 125 to adequately compensate media content providers 130 and ensure that the system remains both solvent and profitable. For example, if the average song is three and a half minutes long, and four advertisements 127 at a time are displayed for thirty seconds each on the device 210 while the user 100 listens to the song, advertising rates may be set such that the twenty eight advertisements 127 that are displayed while the song plays generate sufficient revenue to compensate the media content owner 130 for the song and to leave sufficient revenue for the system owner to maintain the system profitably.

The advertising fee 125 may be further calculated as a function of whether the user 100 chooses to view information related to the advertisement 127 but not actually contained within the advertisement 127. For example, if the user 100 were to click on an advertisement 127 displayed on the device 210 while viewing a music video, the click may result in the user 100 being directed to the advertiser's web site, and the advertiser 120 may be charged an additional component to the advertising fee 125. Alternatively, selecting an advertisement may result in additional information about the item advertised to be displayed in the distribution portal 220 (e.g., in the display section 430) without the user being directed to a different web site. Further, if the user 100 chose to purchase an item from the advertiser 120, yet another component could be added to the advertising fee. Accordingly, it is possible to incorporate the CPM, CPC, CPA, and CPL advertising models into the larger CPT model.

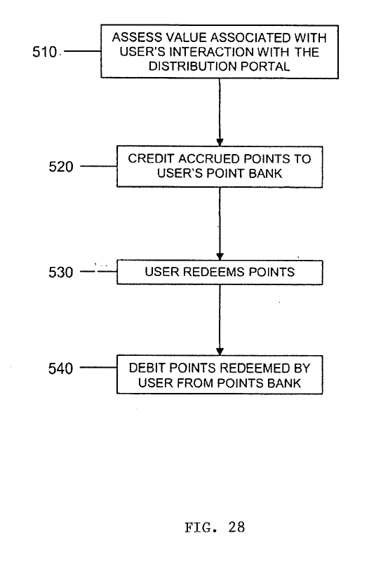

FIG. 28 is a flow chart depicting an exemplary method by which a user 100 may accrue and/or redeem points in a points bank 234. At step 510 the administrative system 110 assess the value associated with the user's interaction with the distribution portal 220. A user 100 may accrue points in the points bank 234 based on the user's engagement with the distribution portal 220. The points accrued by the user 100 may be a function of the time that the user 100 spends interacting with the distribution portal 220, the types of advertisements 127 that are displayed in the advertising section 450 while the user 100 is interacting with the distribution portal 220, the type of media content 135 with which the user 100 engages, the relative popularity of the media content 135 that the user 100 views or hears, the number of advertisements 127 that are displayed while the user 100 is engaged with the distribution portal 220, any other relevant or appropriate criteria, and/or any combination thereof.

In one embodiment, it may be preferable that after viewing or listening to a particular media content 135 (e.g., after listening to a whole song or viewing a whole movie), the user has accumulated sufficient points in his or her points bank 234 to be able to download or copy the media content 135 to the device 210 or another device as desired. However, the user 100 need not use the accrued points to download the same media content 135 through which the user 100 accrued the points. For example, the user 100 may listen to a first song and use the points accrued while listening to the song to download a different song.

In one embodiment, a user 100 may accrue additional or extra points for viewing media content 135 that commands premium advertising rates, or for which the media content provider 130 agrees to provide the user 100 with additional or extra points as an incentive for users 100 to engage the media content 135.

In another embodiment, the number of points accrued by a user 100 for viewing particular media content 135 may be derived from the value of advertising revenue received through the administrative system 110. For example, a first item of media content 135 may command premium advertising rates because it may be extremely popular, and numerous advertisers 120 may desire to place their advertisements 127 in association with that particular item of media content 135. A second item of media content 135 may command lower advertising rates because it may be less popular, and attract fewer advertisers 120 who wish to place their advertisements 127 in connection with that particular item of media content 135. One may design a system according to the present disclosure in which a user accumulates more points in the points bank 234 for engaging with the first item of media content and accumulates less points in the points bank for engaging with the second item of media content.

It is to be understood that the present disclosure is broad enough to encompass any implementation of an account, file, data and/or system for recording and/or tracking a user's interaction with the system. Thus for example, and not by way of limitation, instead of accruing points a user may accrue shares, currency, a currency equivalent or any other metric that may serve as a proxy for and/or track the user's interaction with the system or the distribution portal.

At step 520, the points accrued by the user through interacting with the distribution portal 220 are credited to a user's points bank 234. The points bank 234 may be maintained by the administrative system 110, for example, on a storage device 232, or it may be maintained on the user's device 210, or it may be maintained on both the storage device 232 and the user's device 210. If stored on the device 210, the user 100 may be able to check the balance of the points bank 234 even when the user 100 is not logged into or otherwise engaged with the distribution portal 220.

At step 530, the user 100 may be permitted to redeem the points accrued in the points bank 234. In one embodiment the user 100 may use the points accrued in the points bank 234 to obtain copies of media content 135 to be downloaded to a device 210 with a valid copyright (or other intellectual property, as applicable) license. If the user 100 chooses to redeem points in this manner, the user 100 may be able to later view or listen to the downloaded media content without being logged into or otherwise engaged with the distribution portal 220. The system and method of the present disclosure may use secure transfer or encryption technology, digital rights management technology, water marking technology, or any other appropriate technology to ensure that downloaded copies of media content 135 are used in compliance with the terms of the license granted to the user 100.

When a user 100 redeems points in his or her points bank 234 to download or otherwise receive a copy of a media content 135, the advertising fees 125 that were generated while the user 100 was accruing the points may be split between the media content provider 130 and the owner and/or administrator of the administrative system 110 and distribution portal 220, any other entities as appropriate, and/or any combination thereof. In this manner, the media content provider 130 receives compensation for the transfer of electronic media content 135 while the owner of the distribution system generates revenue for the continued operation of the distribution system 10. The percentage and/or amount of the advertising revenue that is paid to the media content owner 130 may be a function of the length (measured in time) of the media content 135, the number of advertisements 127 displayed while the user 100 engaged with the media content 135, the relative popularity of the media content 135, any other relevant characteristics, or any combination thereof. The owner and/or administrator of the administration system 110 and distribution portal 220 may also be paid a fee as a percentage of the advertising revenue 125 generated through the system 10.

In another embodiment, the user 100 may be permitted to redeem the points accrued in his or her points bank 234 to purchase products or services other than the media content 135 available through the distribution portal 220. For example, the user 100 may be permitted to use points in his or her points bank 234 to obtain products or services offered by the advertisers 120. When a user 100 redeems points in his or her points bank 234 to obtain products or services in the manner described, the advertising fees 125 that were generated while the user 100 was accruing the points may be split between one or more of the advertisers from which the user 100 obtains the product or service, the owner and/or administrator of the administrative system 110, the media content provider 130, any other entities as appropriate, and/or any combination thereof.

In yet another embodiment of the disclosure, the user 100 may choose to redeem the points in his or her points bank 234 for actual currency. This redemption of points for actual currency could take the form of, but is not limited to, cash, a rebate check, a preloaded debit or credit card, a deposit in a PayPal or similar account, a deposit in a traditional bank account, or as a credit against an outstanding bill, such as a cable bill. When a user 100 redeems points in his or her points bank 234 to obtain currency in the manner described, the advertising fees 125 that were generated while the user 100 was accruing the points may be divided among the user 100, the owner of the administrative system 110, the media content provider 130, any other entities as appropriate, and/or any combination thereof.

When the user 100 redeems some or all of the points in his or her points bank 234, at step 540 the user's points bank 234 is debited so as to reflect the balance of the points bank 234 after subtracting the points redeemed.

In one embodiment of the disclosure, because the total number of advertisements 127 that may be placed by advertisers 120 may vary during predetermined time periods (e.g., from one week to another, from one month to another, etc.), and because the amount of advertising fees 125 that may be charged for the advertisements 127 during any given time period may vary (e.g., the advertising rates as set by a first sweeps period may differ from advertising rates as set by a second sweeps period, or the advertising rates during certain times of the day may differ from advertising rates during different times of the day), the amount of advertising revenue that may be provided to media content provider 130 for users' download of its media content 135 may differ from one given time period to another. For example, assume that a user 100 needs thirty points in his or her points bank to download a song to his device 210, and that a user may accumulate those thirty points by interacting or engaging three minutes with the distribution portal 220. Assume further that in a first quarter of the year, the number and duration of the advertisements displayed while a user accumulate thirty points for engaging with the system may generate X dollars in revenue, whereas in a second quarter of the year the number and duration of the adds displayed while a user accumulates thirty points for engaging with the system may generate Y dollars in revenue (where Y may be higher or lower than X). Accordingly, when a user redeems thirty points in a first quarter to download a song, the media content owner 130 will receive a percentage of X dollars, whereas when the user redeems thirty points in a second quarter to download the same song, the media content owner 130 will receive a percentage of Y dollars. In other words, the worth of the media content in any given time period may be a function of the amount of advertising revenue that may be generated during that time period.

According to such an embodiment, it may be desirable to calculate a blended advertising rate per second based on the total advertising revenue generated during a given time period (e.g., during a week, a month, a quarter, etc.). Equation I below sets forth a method of calculating a blended advertising rate:

B=A/T (equation 1)

### Wherein:

B=blended advertising rate per second for a given time period (e.g., a particular month, a particular quarter, a particular sweeps period, etc.)
A=total advertising revenue generated during the same time period
T=total time spent by users interacting with the distribution portal during the same time period

Equation 2 below sets forth a method of calculating the revenue attributable to a specific media content during a given time period based on the blended advertising rate obtained from equation 1:

R=B×D (equation 2)

### Wherein:

R=revenue attributable to a media content for a given time period
B=blended advertising rate per second for the same time period
D=duration of the media content

The revenue attributable to a particular media content may be split between the media content provider 130 and the owner and/or administrator of the administrative system 110 and distribution portal 220, any other entities as appropriate, and/or any combination thereof as discussed herein.

Equation 3 below sets forth a method of calculating the value of shares accumulated by users during a given time period based on the blended advertising rate obtained from equation 1:

V=B×S (equation 3)

### Wherein:

V=value of shares accumulated by a user for a given time period
B=blended advertising rate per second for the same time period
S=number of shares accumulated by a user during the same time period

A user may then redeem the value of the points in his or her points bank to obtain media content, products, or services as described herein.

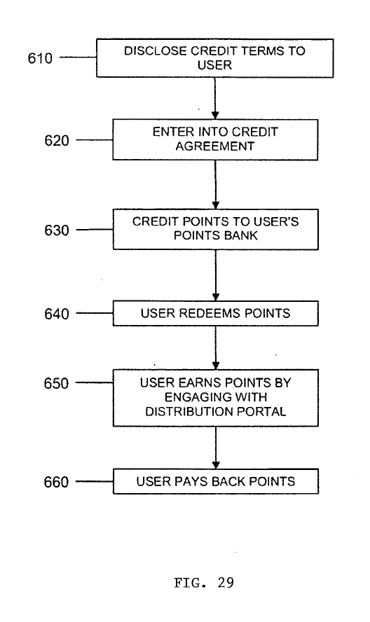

FIG. 29 is a flow chart depicting an exemplary embodiment in which a user 100 is awarded points in his or her points bank 234 before the user has earned the points through his or her engagement with the distribution portal 220, and thereby creating a credit system for earning and using points in a points bank. At step 610, the administrative system 110 either directly or through a third party agent discloses the terms and conditions of a credit agreement to the user 100, including but not limited to, the credit limit and any applicable interest rate. At step 620, the user 100 and the administrative system 110 enter into a credit agreement. At step 630 the administrative system 110 extends credit to the user 100 by, for example, crediting points to the user's points bank 234 that the user 100 has not yet earned through engagement with the distribution portal 220. At step 640, the user 100 may redeem the points awarded to his points bank 234 to acquire any media content 135, or any other products, services or currency that the user 100 would otherwise be able to acquire by redeeming points. At step 650 the user 100 acquires points in his points bank by engaging with the distribution portal 220. At step 660, the user 100 redeems the points he or she has accrued to pay back the points that were credited to his points bank 234 (with or without interest as may be appropriate) based on the terms of the credit agreement.

One advantage of extending credit to users 100 in this manner may be that it creates additional profits for the distribution system 10 by encouraging users 100 to spend more time interacting with the distribution portal 220 in order to repay the credit extended to them. Increasing the amount of time a user 100 spends interacting with the portal 220, in turn, generates more advertising revenue 125 which can be distributed as discussed in greater detail above. Further, if interest payments are assessed, those payments can be distributed to the owner and/or administrator of the administration system 110 and/or the distribution portal 220, media content providers 130, and/or other entities as desired or appropriate.

The systems and methods disclosed herein may provide additional features designed to improve the overall appeal of the system to users 100, media content providers 130, and advertisers 120. For example, the disclosure may provide mechanisms for tracking and recording the demographics of users 100. For example, it may be desirable to collect and store information relating to the geographic distribution of users 100. Geographic regions may be categorized by political boundaries, such as state, county, and city, or other regions as appropriate. For example, in one embodiment of the disclosure, each state may be assigned a number and each county or district may be assigned a letter. Geographic location information may be obtained each time the user 100 accesses media content 135 by, for example, using the IP address of the user's device 210 to determine geographic location. Alternatively, the user's geographic location could be stored as part of a profile associated with a user profile or points bank 234. In yet another alternative, a record may be made of the fact that a user 100 resides in a geographic location without actually associating that fact with the particular user. In this manner, the operator of the distribution portal 220 could store information about the generalized geographic distribution of registered users without saving private details of any particular user. Similarly, each user 100 could provide information about his or her gender and/or age bracket.

A media content provider 130 could be provided some form of access to this demographic information in order to better market his or her media content 135. As one example, a media content provider 130 which is a small music publishing company could use such demographic information to determine where to product place a CD in a retail store. Demographic and geographic information could help an artist to obtain endorsement contracts in a particular region or provide accurate numbers for estimated concert attendances. Advertisers 120 could use this information to target specific geographic regions, particular demographics, and/or consumer preferences. The present disclosure also enables local advertisers 120 to gain access to a local or regional markets without wasting advertising budget on users 100 who, for whatever reason, are unlikely to make use of the advertised product or services. For example, a club promoter could target the surrounding geographic region to advertise an upcoming show.

The distribution portal 220 may also be used by the various participants—the media content provider 130, the advertiser 120, and the user 100—to view relevant statistics about the system. For example, the media content provider 130 may wish to view the number of downloads of that provider's media content 135, the amount of advertising fees 125 payable to the provider 130, and other relevant information as desired. As another example, the advertiser 120 may wish to view the popularity of media content 135 or user preferences.

While many of the examples provided herein focus on web-based distribution portals 220, it should be understood that the systems and methods disclosed herein are applicable in a wide variety of applications. In an alternative example, the system 10 is also applicable to television markets. These markets include, without limitation, network television, satellite television, and cable television. The operators of these television markets could function as the administrative system 110 and implement the CPT model disclosed herein. A television (in conjunction with a set-top-box, digital video recorder, or other hardware as necessary) may function as a distribution portal 220 and a device 210, and one or more advertisements 127 may be displayed at the same time as media content 135, such as a television show. For example, advertisements 127 could be displayed at the bottom of the television screen much like a ticker on a news channel As in the foregoing examples, the user 100 may create value from exposure to the advertisements 127 based on the CPT model, and the television—acting as a distribution portal 220—may record the amount of time the user spends while interacting with the portal 220 by watching television. In this embodiment, the administrative system 110 may have strategic partnerships with one or more network television providers, who can reach virtually any home that receives over-the-air television, satellite television, cable television or internet-based television.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other foam of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While the systems and methods described herein may be implemented to permit a user to download media content with no out of pocket expense to the user, it is to be understood that the disclosure herein is broad enough to encompass systems and methods in which a user uses a combination of points accrued in his or her points bank as described herein and currency (e.g., cash, check, credit card, debit card, etc.) to download songs. For example, the user may use the points accrued in his or her points bank to obtain a discount on the fee the user would otherwise have to pay to download a copy of the media content or purchase a product from an advertiser. In other words, the disclosure is broad enough to cover systems and methods in which a user may incur out of pocket expense when downloading or otherwise copying media content.

It is to be understood that a person or entity may have multiple roles in the system and method as described herein. For example, a person may be a user 100 while at the same time providing media content for distribution through the system as a media content provider 130. As another example, an advertiser 120 may also be a media content provider 130. Nothing herein is intended to limit the roles that a person or entity can have within the systems and methods described herein.

While the system and methods herein have been described with respect to one distribution portal, the scope of the disclosure is not so limited. By way of example and not limitation, it is also possible within the scope of the present disclosure to provide more than one distribution portal 220 wherein a user's interactions with any of the distribution portals is tracked and his/her points bank credited or debited based on the user's interaction with any one of the distribution portals. Accordingly, a user may access a first distribution portal to interact with the media content on the first distribution portal while at the same time being exposed to one or more advertisements, but redeem the points the he accrued through the interaction with the first distribution portal for media content on a second distribution portal. In such an embodiment, the one or more distribution portals may choose to implement a system to enable a user to utilize a universal log-in, whereby the user logs-in once and his interactions on the various distribution portals are tracked and his/her points bank credited or debited as appropriate without the user having to log into the one or more distribution portals individually or one at a time.

It is also within the scope of the present disclosure to share a percentage of the advertising revenue generated with the owner of media content with which a user interacts but that a user does not download or copy to a device 210. For example, there may be some types of media content (e.g., news articles or blog postings) that may be very popular with users but that user's may not necessarily download to their device 210 after viewing the media content. To incentivize the owners of such media content to continue to produce and provide such media content, the owners of such media content may be provided with a percentage of the revenue generated through the display of advertisements while the user interacted with the media content. The same approach may be taken with respect to any media content (e.g., songs, television shows, movies, etc.) with which a user interacts but does not necessarily download or copy to a device 210.

It is to be understood that variations, permutations, and modifications of the systems, methods and apparatuses of the present invention may be made without departing from the scope thereof. One or more features of an exemplary embodiment as described above may be practiced in conjunction with other exemplary embodiments as described above.

It is also to be understood that the systems, methods and apparatuses of the present invention are not to be limited by the specific embodiments or examples disclosed herein, but only in accordance with the appended claims when read in light of the foregoing specification.

What is claimed is:

1. A system for generating revenue for an identified cause comprising an on-line social impact marketing platform, said platform further comprising:
a. at least one on-line access portal for participants to interface with the platform;
b. at least one tool for generating revenue based on actions by participants;
c. at least one tool for marketing the results of revenue generating actions of participants;
d. at least one tool for converting between points and revenue; and
e. an administrative system for tracking participants, measuring and verifying revenue generation, and collecting and distributing generated revenue.

2. The system of claim 1 wherein said at least one tool for generating revenue is registering an item of a purchaser selected from the group of: a credit card, a debit card, a rewards card, a mobile application, a bank transaction, and combinations thereof, so that a percentage of purchases made using said registered item are directed toward said cause.

3. The system of claim 1 wherein said at least one tool for generating revenue is registration by the participant of any digitally measurable transaction linked to the portal.

4. The system of claim 1 wherein said at least one tool for generating revenue is registering with at least one merchant such that a percentage of purchases made from said at least one merchant are directed toward said cause.

5. The system of claim 1 wherein said at least one tool for generating revenue is an in-store terminal that has been registered with said portal so that a percentage of purchases made using said terminal are directed toward said cause.

6. The system of claim 1 wherein said at least one tool for generating revenue is an on-line terminal that has been registered with said portal so that a percentage of purchases made using said terminal are directed toward said cause.

7. The system of claim 1 wherein said at least one marketing tool is a social impact meter.

8. The system of claim 1 wherein said at least one marketing tool is an integrity meter.

9. The system of claim 1 wherein said at least one marketing tool is a participant home page.

10. The system of claim 1 wherein said cause is an identified nonprofit organization.

11. The system of claim 1 wherein said cause is an identified social need.

12. The system of claim 1 wherein said cause is an identified entity.

13. The system of claim 1 wherein said cause is an identified project.

14. The system of claim 1 wherein participants are selected from the group consisting of: consumers, merchants, merchant processors, financial institutions, and nonprofits and combinations thereof.

15. The system of claim 1 wherein participants are selected from the group consisting of: celebrities, public figures, brands, and combinations thereof.

16. The system of claim 1 further comprising a clearinghouse for creating and converting points.

17. The system of claim 1 further comprising a home page for each participant.

18. The system of claim 1 further comprising a competitive giving marketplace.

19. The system of claim 16 further comprising at least one tool for establishing a competitive event.

20. The system of claim 19 further comprising at least one tool for establishing teams for said competitive event.

21. The system of claim 1 further comprising links to social media.

22. A method for generating revenue for a cause through a competitive giving marketplace comprising the steps of:
a. allowing a first participant to log into an on-line access portal, and establish a competitive event, at least two competitive teams, an end date for the event, and rules therefor in order to generate revenue for a cause;
b. allowing said first participant to choose a first team;
c. allowing at least one subsequent participant to log into said portal and choose a second team;
d. allowing additional participants to log into said portal and choose a team;
e. providing at least one tool for generating revenue based on actions by participants;
f. publicizing revenue generated from participants' use of said at least one tool for generating revenue according to each participant's team membership; and
g. distributing revenue to said cause after the end date of the event.

23. The method of claim 22 wherein said at least one tool for generating revenue is registering an item of a purchaser selected from the group of: a credit card, a debit card, a rewards card, a mobile application, a bank transaction, and combinations thereof, so that a percentage of purchases made using said registered item are directed toward said cause.

24. The method of claim 22 wherein said at least one tool for generating revenue is registration by the participant of any digitally measurable transaction linked to the portal.

25. The method of claim 22 wherein said at least one tool for generating revenue is registering with at least one merchant such that a percentage of purchases made from said at least one merchant are directed toward said cause.

26. The method of claim 22 wherein said at least one tool for generating revenue is an in-store terminal that has been registered with said portal so that a percentage of purchases made using said terminal are directed toward said cause.

27. The method of claim 22 wherein said at least one tool for generating revenue is passive on-line activity of a participant.

28. The method of claim 22 wherein said event is a competition having at least two teams.

29. A method for generating revenue for a cause through a competitive giving marketplace comprising the steps of:
a. allowing a first participant to log into an on-line access portal, and establish a competitive event, an end date for the event, and rules therefor in order to generate revenue for a cause;
b. allowing subsequent participants to log into said portal and participate in the event;
c. providing at least one tool for generating revenue based on actions by participants;
d. publicizing revenue generated from participants' use of said at least one tool for generating revenue; and
e. distributing revenue to said cause after the end date of the event.

30. The method of claim 29 wherein said event is a virtual game board having spaces where participants “land”, with each space requiring a participant to interact with that space in order to move on such that a participant completes the game by interacting with every space of the game board.

31. The method of claim 30 wherein at least one merchant is associated with at least one space on the virtual game board.

32. The method of claim 30 wherein a participant must use a revenue generating tool at least one space on said virtual game board in order to advance from that space.

33. The method of claim 30 wherein a merchant has more than one space on said virtual game board.

34. The method of claim 30 comprising the additional steps of establishing teams for the competitive event, and a participant joining a team, wherein said participant participates in the event for the joined team so that at least one point generated from such participation goes to a cause associated with the joined team.

35. The method of claim 30 wherein different amounts of revenue are generated by different spaces on the virtual game board.

36. The method of claim 30 wherein each space creates revenue for a cause.

37. The method of claim 36 wherein revenue for a cause is converted into a point.

38. The method of claim 30 wherein rewards are given for using a revenue generating tool at least one space on the game board.

39. The method of claim 30 wherein a participant competes with at least one other participant.

40. A method for generating revenue for a cause through activity comprising the steps of:
a. allowing a participant to log into an on-line access portal, and identify activity of the participant to be used to generate revenue for a cause;
b. tracking the activity of said participant;
c. generating at least one point from the activity of said participant;
d. accumulating total points generated by the activity of said participant;
e. determining the monetary value of said at least one point; and
d. distributing the monetary value of points to said cause at the instruction of said participant.

41. The method of claim 40 wherein said activity of said participant is use by the participant of an item selected from the group consisting of: a credit card, a debit card, a rewards card, a mobile application, a bank transaction, and combinations thereof.

42. The method of claim 40 wherein said activity of said participant is use by the participant of any digitally measurable transaction linked to the portal.

43. The method of claim 40 wherein said activity of said participant is use of an online application.

44. The method of claim 40 wherein said activity of said participant includes purchases by the participant from at least one identified merchant.

45. The method of claim 40 wherein said activity of said participant includes allowing the placement of advertising while the participant is on-line using the Internet, and monitoring the amount of time that the participant spends on-line while such advertising is in place.

46. The method of claim 40 wherein the step of generating at least one point further comprises comparing the value of an advertisement, the duration of the advertisement, and the amount of time that the participant spends on-line while such advertising is in place.

47. The method of claim 40 wherein the step of determining the monetary value of said at least one point further comprises comparing the total amount of time spent on-line by consumer participants seeking to generate revenue for said cause with the total amount of revenue produced by said consumer participants through purchases made while on-line.

48. A system for generating revenue through an on-line social impact marketing platform comprising:
an application server adapted to perform a method of data management comprising:
a. providing at least one on-line access interface for participants to register with the platform;
b. using at least one tool to generate revenue based on actions by participants;
c. using at least one tool to market the results of revenue generating actions of participants;
d. providing at least one tool for converting between points and revenue; and
e. providing an administrative system for tracking participants, measuring and verifying revenue generation, and collecting and distributing generated revenue.

49. The system of claim 48 comprising the additional step of providing a clearing house for distributing points to at least one designated participant.

50. The system of claim 48 comprising the additional step of creating a point for donative purposes to said participant.

51. The system of claim 48 comprising the additional step of providing an interface to enable a participant to make a donation.

52. The system of claim 48 comprising the additional step of providing an interface to share information about an organization

53. The system of claim 52 wherein said interface is an integrity meter.

54. The system of claim 52 wherein said interface is a social impact meter.

55. The system of claim 48 comprising the additional step of providing an interface to view analytics about an organization through marketing tools.
